(19) United States
(12) Patent Application Publication
(10) Pub. No.: US 2026/0202673 A1
(43) Pub. Date: Jul. 16, 2026

(54) METHOD AND SYSTEM FOR HIGH ORDER DIFFRACTION, LARGE FIELD OF VIEW AUGMENTED REALITY EYEPIECE WAVEGUIDES

(71) Applicant: Magic Leap, Inc., Plantation, FL (US)

(72) Inventors: Vikramjit Singh, Pftugerville, TX (US); Chinmay Khandekar, Sunnyvale, CA (US); Qizhen Xue, Austin, TX (US); Mohammadsadegh Faraji-Dana, Sunnyvale, CA (US)

(73) Assignee: Magic Leap, Inc., Plantation, FL (US)

(21) Appl. No.: 19/562,066

(22) Filed: Mar. 10, 2026

Related U.S. Application Data
(63) Continuation of application No. PCT/US2023/032806, filed on Sep. 14, 2023.

(51) Int. Cl. G02B 27/01; G02B 27/00; G02B 27/42

(52) U.S. Cl. CPC G02B 27/0172; G02B 27/0081; G02B 27/4205; G02B 27/4272; G02B 2027/0112; G02B 2027/0125; G02B 2027/0178

(57) ABSTRACT

A method of operating an eyepiece waveguide of an augmented reality system includes projecting virtual content using a projector assembly and diffracting the virtual content into the eyepiece waveguide via a first order diffraction. A first portion of the virtual content is clipped to produce a remaining portion of the virtual content. The method also includes propagating the remaining portion of the virtual content in the eyepiece waveguide, outcoupling the remaining portion of the virtual content out of the eyepiece waveguide, and diffracting the virtual content into the eyepiece waveguide via a second order diffraction. A second portion of the virtual content is clipped to produce a complementary portion. The method further includes propagating the complementary portion of the virtual content in the eyepiece waveguide and outcoupling the complementary portion of the virtual content out of the eyepiece waveguide.

### CROSS-REFERENCE TO RELATED APPLICATIONS

This application is a continuation of and claims the benefit of and priority to International Patent Application No. PCT/US2023/032806, filed Sep. 14, 2023, entitled “METHOD AND SYSTEM FOR HIGH ORDER DIFFRACTION, LARGE FIELD OF VIEW AUGMENTED REALITY EYEPIECE WAVEGUIDES,” the entire contents of which is hereby incorporated by reference for all purposes.

### BACKGROUND OF THE INVENTION

Modern computing and display technologies have facilitated the development of systems for so-called “virtual reality” or “augmented reality” experiences, wherein digitally reproduced images or portions thereof are presented to a viewer in a manner wherein they seem to be, or may be perceived as, real. A virtual reality, or “VR,” scenario typically involves presentation of digital or virtual image information without transparency to other actual real-world visual input; an augmented reality, or “AR,” scenario typically involves presentation of digital or virtual image information as an augmentation to visualization of the actual world around the viewer.

Referring to FIG. 1, an augmented reality scene 100 is depicted. The user of an AR technology sees a real-world park-like setting featuring people, trees, buildings in the background 106, and a concrete platform 120. The user also perceives that he/she “sees” “virtual content” such as a robot statue 110 standing upon the real-world concrete platform 120, and a flying cartoon-like avatar character 102 which seems to be a personification of a bumble bee. These elements 110 and 102 are “virtual” in that they do not exist in the real world. Because the human visual perception system is complex, it is challenging to produce AR technology that facilitates a comfortable, natural-feeling, rich presentation of virtual image elements amongst other virtual or real-world imagery elements.

Despite the progress made in these display technologies, there is a need in the art for improved methods and systems related to augmented reality systems, particularly, display systems.

### SUMMARY OF THE INVENTION

The present invention relates generally to methods and systems related to projection display systems including wearable displays. More particularly, embodiments of the present invention provide methods and systems for improving the visual performance of augmented reality systems. As described herein, diffractive optics eyepiece architectures incorporating high index of refraction eyepiece waveguide substrates are provided that utilize second order diffraction to enhance the efficiency of an augmented reality (AR) display. The invention is applicable to a variety of applications in computer vision and image display systems.

As described more fully herein, embodiments of the present invention utilize second order diffraction in the eyepiece waveguide (analyzed in k-space for clarity) to enable “filling” out blue wavelengths in the visible field of view formed as light exits towards the user's eye. The diffractive structures in the combined pupil expander are such that when combined with a high index substrate, for example, a substrate with an index of refraction greater than 2.0 (e.g. LiNbO₃, LiTaO₃, SiC, etc.), the propagation and exit of nasal side angles at blue wavelengths that would otherwise not be fully visible for a monocular large field of view display using such a waveguide display is enabled. The light diffracted in the second order may be characterized by reduced intensity. However, as described herein, the incoupling gratings can be tuned to enable the high angle second order diffracted light to launch more effectively. Additionally, viewing such images in a binocular device can provide a more enhanced immersive AR/MR experience in comparison with waveguide displays that clip such content.

Numerous benefits are achieved by way of the present invention over conventional techniques. For example, embodiments of the present invention provide methods and systems that support a field of view utilizing second order diffraction launch that is larger than that provided by conventional designs. Thus, using high index of refraction substrates, the eyepiece waveguides described herein achieve higher FOV with high-index glass substrates. Moreover, the embodiments discussed herein provide new designs for eyepieces, also referred to as eyepiece waveguides, allowing more viewable field of view for virtual images waveguided towards users via the use of second order diffractive waveguide combiners. With such architectures, single active layer, large field of view devices, for example, devices with a field of view greater than 65 degrees, are enabled over the visible spectrum in a more compact area suitable for eyepiece designs used in wearables, thus reducing complexity, reducing weight, improving see-thoroughness, the dependence of multiple launch axes on polarization sensitive architectures, and the like. These and other embodiments of the invention along with many of its advantages and features are described in more detail in conjunction with the text below and attached figures.

### BRIEF DESCRIPTION OF THE DRAWINGS

FIG. 1 illustrates a user's view of augmented reality (AR) through an AR device.

FIG. 2A illustrates a cross-sectional side view of an example of a set of stacked waveguides that each includes an incoupling optical element.

FIG. 2B illustrates a perspective view of an example of the one or more stacked waveguides of FIG. 2A.

FIG. 2C illustrates a top-down plan view of an example of the one or more stacked waveguides of FIGS. 2A and 2B.

FIG. 2D is a simplified illustration of an eyepiece waveguide having a combined pupil expander according to an embodiment of the present invention.

FIG. 2E illustrates an example of a wearable display system according to an embodiment of the present invention.

FIG. 3 shows a perspective view of a wearable device according to an embodiment of the present invention.

FIG. 4A is a simplified cross-sectional diagram illustrating elements of an eyepiece waveguide according to an embodiment of the present invention.

FIG. 4B is a simplified k-space diagram illustrating the field of view and grating vectors for an eyepiece waveguide according to an embodiment of the present invention.

FIG. 4C is a simplified plan view of the world side of a combined pupil expander (CPE) of an eyepiece waveguide according to an embodiment of the present invention.

FIG. 4D is a simplified plan view of the user side of the CPE shown in FIG. 4C.

FIG. 5A is a simplified k-space diagram illustrating the field of view and ICG grating vectors for an eyepiece waveguide with a 16°×16° field of view according to an embodiment of the present invention.

FIG. 5B is a simplified k-space diagram illustrating the field of view and ICG grating vectors for an eyepiece waveguide with a 39°×39° field of view according to an embodiment of the present invention.

FIG. 6 is a simplified ray tracing diagram illustrating first order diffraction of input light and second order diffraction of blue light according to an embodiment of the present invention.

FIG. 7A is a simplified k-space diagram illustrating the field of view, ICG grating vectors, and CPE grating vectors for an eyepiece waveguide with multiple diffraction orders according to an embodiment of the present invention.

FIG. 7B is a simplified plan of the world side of an eyepiece waveguide with multiple diffraction orders according to an embodiment of the present invention.

FIG. 7C is a simplified plan of the user side of an eyepiece waveguide with multiple diffraction orders according to an embodiment of the present invention.

FIG. 8A is a simplified k-space diagram illustrating the field of view and ICG grating vectors for an eyepiece waveguide with one-dimensional and two-dimensional gratings and multiple diffraction orders according to an embodiment of the present invention.

FIG. 8B is a simplified k-space diagram illustrating the field of view and CPE grating vectors for an eyepiece waveguide with one-dimensional and two-dimensional gratings and multiple diffraction orders according to an embodiment of the present invention.

FIG. 8C is a simplified plan of the world side of an eyepiece waveguide with one-dimensional and two-dimensional gratings and multiple diffraction orders according to an embodiment of the present invention.

FIG. 8D is a simplified plan of the user side of an eyepiece waveguide with one-dimensional and two-dimensional gratings and multiple diffraction orders according to an embodiment of the present invention.

FIG. 8E is a plot of the eyebox efficiency for a red wavelength across the full field of view for an eyepiece according to an embodiment of the present invention.

FIG. 8F is a plot of the eyebox efficiency for a green wavelength across the full field of view for an eyepiece according to an embodiment of the present invention.

FIG. 8G is a plot of the eyebox efficiency for a blue wavelength across the full field of view for an eyepiece according to an embodiment of the present invention.

FIG. 9A is a simplified cross-sectional schematic diagram illustrating an etched grating supporting first and second order launch according to an embodiment of the present invention.

FIG. 9B is a simplified cross-sectional schematic diagram illustrating an etched metabinary grating supporting first and second order launch according to an embodiment of the present invention.

FIG. 9C is a simplified cross-sectional schematic diagram illustrating a double-sided imprint grating supporting first and second order launch according to an embodiment of the present invention.

FIG. 10A is a simplified cross-sectional schematic diagram illustrating a metallic blazed grating for an ICG according to an embodiment of the present invention.

FIG. 10B is a simplified cross-sectional schematic diagram illustrating a single layer metallic coated blazed grating for an ICG according to an embodiment of the present invention.

FIG. 10C is a simplified cross-sectional schematic diagram illustrating a double layer coated blazed grating for an ICG according to an embodiment of the present invention.

FIG. 10D is a simplified cross-sectional schematic diagram illustrating a coating with multiple dielectric layers on a blazed grating for an ICG according to an embodiment of the present invention.

FIG. 11A illustrates diffraction orders for blue light calculated for various blazed angles across the horizontal FOV for an ICG with nano-imprinted photoresist diffractive structures according to an embodiment of the present invention.

FIG. 11B illustrates diffraction orders for blue light calculated for various blazed angles across the horizontal FOV for an ICG with diffractive structures etching into a lithium niobate substrate according to an embodiment of the present invention.

FIG. 12A is a plot of launch efficiency as a function of angle for a blazed ICG that couples efficiently into the first diffraction order according to an embodiment of the present invention.

FIG. 12B is a plot of launch efficiency as a function of angle for a blazed ICG that couples efficiently into the second diffraction order according to an embodiment of the present invention.

FIG. 12C is a plot of launch efficiency as a function of angle for a blazed ICG that couples efficiently into both the first diffraction order and the second diffraction order according to an embodiment of the present invention.

FIG. 13 illustrates diffraction orders for blue light calculated for various blazed angles across the horizontal FOV for the double layer coated blazed grating for an ICG illustrated in FIG. 10C according to an embodiment of the present invention.

FIGS. 14A-14I illustrate various diffraction grating structures that can be utilized in incoupling gratings, orthogonal pupil expander gratings, exit pupil expander gratings, or combined pupil expander gratings according to an embodiment of the present invention.

FIG. 15 is a simplified flowchart illustrating a method of operating an eyepiece waveguide of an augmented reality system according to an embodiment of the present invention.

FIG. 16 is a simplified flowchart illustrating a method of operating an eyepiece waveguide of an augmented reality system according to another embodiment of the present invention.

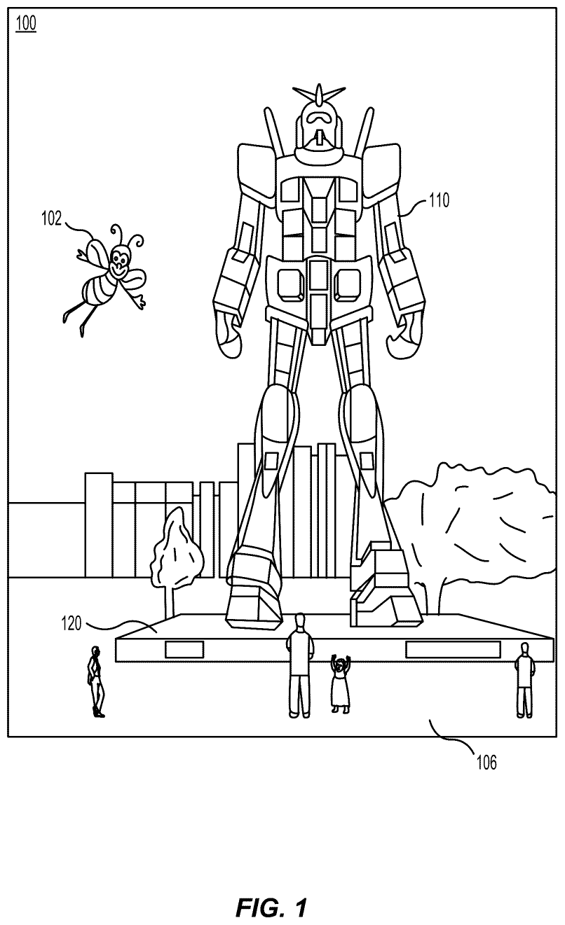

### DETAILED DESCRIPTION OF THE SPECIFIC EMBODIMENTS

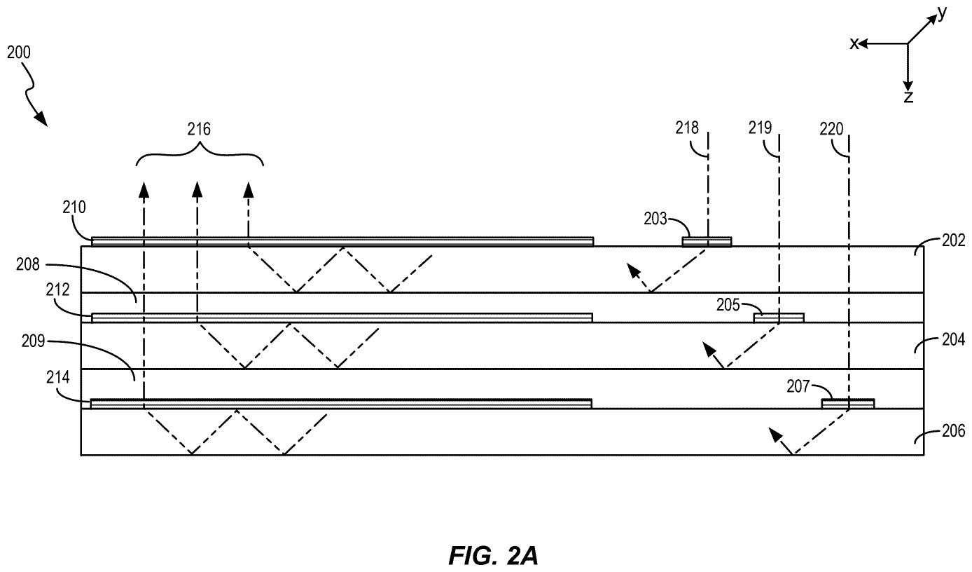

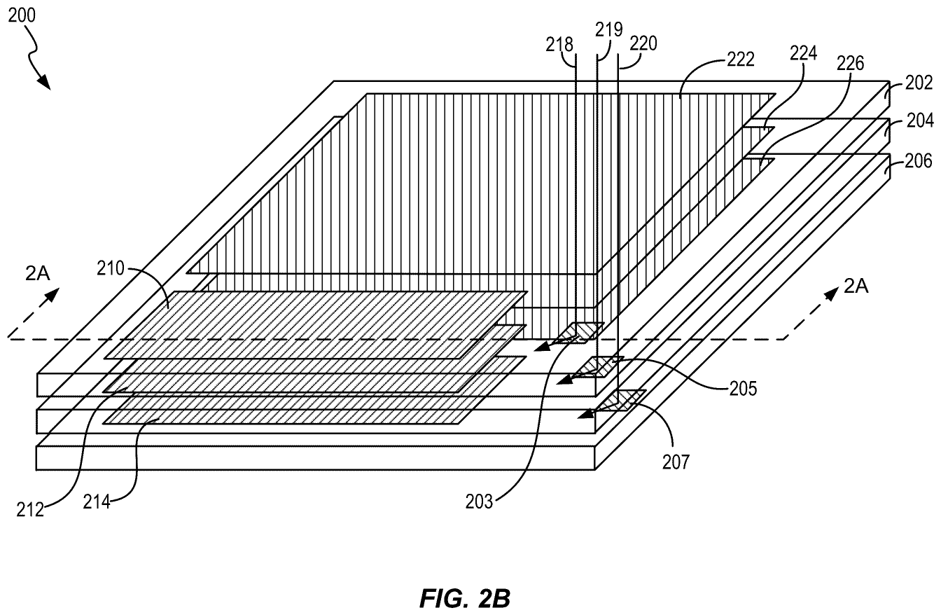

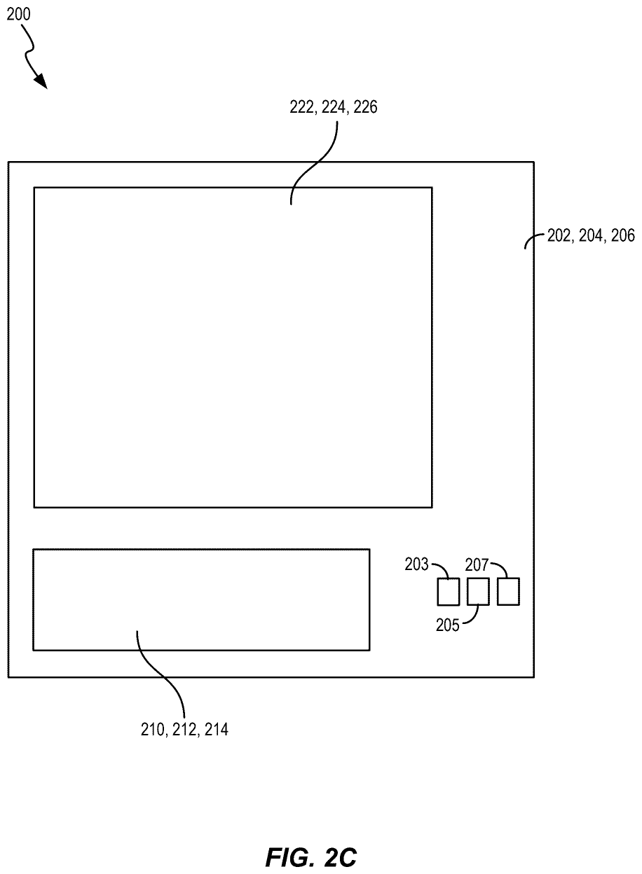

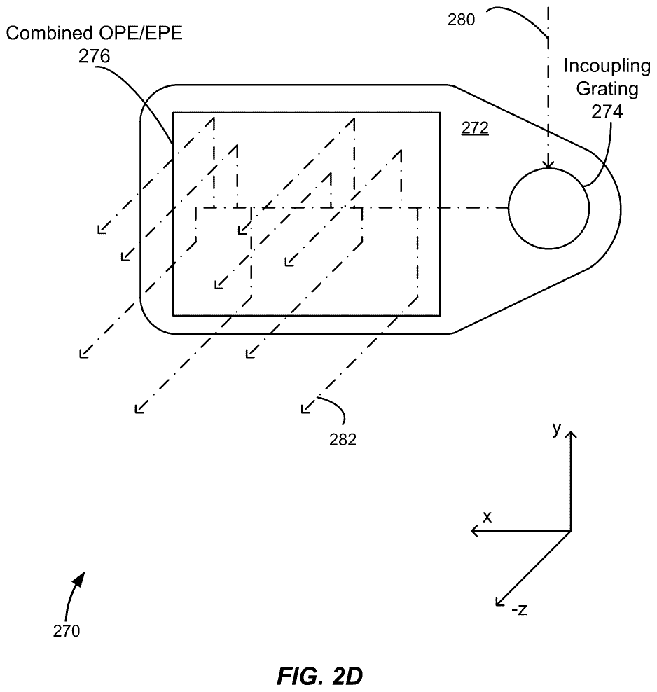

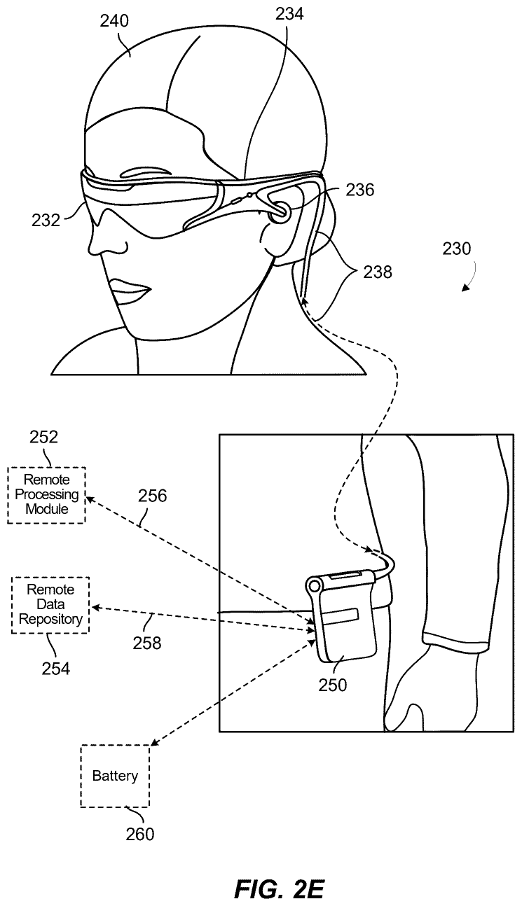

With reference now to FIG. 2A, in some embodiments, light impinging on a waveguide may need to be redirected to incouple that light into the waveguide. An incoupling optical element may be used to redirect and in-couple the light into its corresponding waveguide. Although referred to as “incoupling optical element” through the specification, the incoupling optical element need not be an optical element and may be a non-optical element. FIG. 2A illustrates a cross-sectional side view of an example of a set 200 of stacked waveguides that each includes an incoupling optical element. The waveguides may each be configured to output light of one or more different wavelengths, or one or more different ranges of wavelengths. Light from a projector is injected into the set 200 of stacked waveguides and outcoupled to a user as described more fully below.

The illustrated set 200 of stacked waveguides includes waveguides 202, 204, and 206. Each waveguide includes an associated incoupling optical element (which may also be referred to as a light input area on the waveguide), with, e.g., incoupling optical element 203 disposed on a major surface (e.g., an upper major surface) of waveguide 202, incoupling optical element 205 disposed on a major surface (e.g., an upper major surface) of waveguide 204, and incoupling optical element 207 disposed on a major surface (e.g., an upper major surface) of waveguide 206. In some embodiments, one or more of the incoupling optical elements 203, 205, 207 may be disposed on the bottom major surface of the respective waveguides 202, 204, 206 (particularly where the one or more incoupling optical elements are reflective, deflecting optical elements). As illustrated, the incoupling optical elements 203, 205, 207 may be disposed on the upper major surface of their respective waveguide 202, 204, 206 (or the top of the next lower waveguide), particularly where those incoupling optical elements are transmissive, deflecting optical elements. In some embodiments, the incoupling optical elements 203, 205, 207 may be disposed in the body of the respective waveguide 202, 204, 206. In some embodiments, as discussed herein, the incoupling optical elements 203, 205, 207 are wavelength-selective, such that they selectively redirect one or more wavelengths of light, while transmitting other wavelengths of light. While illustrated on one side or corner of their respective waveguides 202, 204, 206, it will be appreciated that the incoupling optical elements 203, 205, 207 may be disposed in other areas of their respective waveguides 202, 204, 206 in some embodiments.

As illustrated, the incoupling optical elements 203, 205, 207 may be laterally offset from one another. In some embodiments, each incoupling optical element may be offset such that it receives light without that light passing through another incoupling optical element. For example, each incoupling optical element 203, 205, 207 may be configured to receive light from a different projector and may be separated (e.g., laterally spaced apart) from other incoupling optical elements 203, 205, 207 such that it substantially does not receive light from the other ones of the incoupling optical elements 203, 205, 207.

Each waveguide also includes associated light distributing elements, with, e.g., light distributing elements 210 disposed on a major surface (e.g., a top major surface) of waveguide 202, light distributing elements 212 disposed on a major surface (e.g., a top major surface) of waveguide 204, and light distributing elements 214 disposed on a major surface (e.g., a top major surface) of waveguide 206. In some other embodiments, the light distributing elements 210, 212, 214 may be disposed on a bottom major surface of associated waveguides 202, 204, 206, respectively. In some other embodiments, the light distributing elements 210, 212, 214 may be disposed on both top and bottom major surfaces of associated waveguides 202, 204, 206, respectively; or the light distributing elements 210, 212, 214 may be disposed on different ones of the top and bottom major surfaces in different associated waveguides 202, 204, 206, respectively.

The waveguides 202, 204, 206 may be spaced apart and separated by, e.g., gas, liquid, and/or solid layers of material. For example, as illustrated, layer 208 may separate waveguides 202 and 204; and layer 209 may separate waveguides 204 and 206. In some embodiments, the layers 208 and 209 are formed of low index of refraction materials (that is, materials having a lower index of refraction than the material forming the immediately adjacent one of waveguides 202, 204, 206). Preferably, the index of refraction of the material forming the layers 208, 209 is 0.05 or more, or 0.10 or less than the index of refraction of the material forming the waveguides 202, 204, 206. Advantageously, the lower index of refraction layers 208, 209 may function as cladding layers that facilitate total internal reflection (TIR) of light through the waveguides 202, 204, 206 (e.g., TIR between the top and bottom major surfaces of each waveguide). In some embodiments, the layers 208, 209 are formed of air. While not illustrated, it will be appreciated that the top and bottom of the illustrated set 200 of waveguides may include immediately neighboring cladding layers.

Preferably, for ease of manufacturing and other considerations, the material forming the waveguides 202, 204, 206 are similar or the same, and the material forming the layers 208, 209 are similar or the same. In some embodiments, the material forming the waveguides 202, 204, 206 may be different between one or more waveguides, and/or the material forming the layers 208, 209 may be different, while still holding to the various index of refraction relationships noted above.

With continued reference to FIG. 2A, light rays 218, 219, 220 are incident on the set 200 of waveguides. It will be appreciated that the light rays 218, 219, 220 may be injected into the waveguides 202, 204, 206 by one or more projectors (not shown).

In some embodiments, the light rays 218, 219, 220 have different properties, e.g., different wavelengths or different ranges of wavelengths, which may correspond to different colors. The incoupling optical elements 203, 205, 207 each deflect the incident light such that the light propagates through a respective one of the waveguides 202, 204, 206 by TIR. In some embodiments, the incoupling optical elements 203, 205, 207 each selectively deflect one or more particular wavelengths of light, while transmitting other wavelengths to an underlying waveguide and associated incoupling optical element.

For example, incoupling optical element 203 may be configured to deflect ray 218, which has a first wavelength or range of wavelengths, while transmitting rays 219 and 220, which have different second and third wavelengths or ranges of wavelengths, respectively. The transmitted ray 219 impinges on and is deflected by the incoupling optical element 205, which is configured to deflect light of a second wavelength or range of wavelengths. The ray 220 is deflected by the incoupling optical element 207, which is configured to selectively deflect light of third wavelength or range of wavelengths.

With continued reference to FIG. 2A, the deflected light rays 218, 219, 220 are deflected so that they propagate through a corresponding waveguide 202, 204, 206; that is, the incoupling optical elements 203, 205, 207 of each waveguide deflects light into that corresponding waveguide 202, 204, 206 to in-couple light into that corresponding waveguide. The light rays 218, 219, 220 are deflected at angles that cause the light to propagate through the respective waveguide 202, 204, 206 by TIR. The light rays 218, 219, 220 propagate through the respective waveguide 202, 204, 206 by TIR until impinging on the waveguide's corresponding light distributing elements 210, 212, 214, where they are outcoupled to provide out-coupled light rays 216.

With reference now to FIG. 2B, a perspective view of an example of the stacked waveguides of FIG. 2A is illustrated. As noted above, the in-coupled light rays 218, 219, 220, are deflected by the incoupling optical elements 203, 205, 207, respectively, and then propagate by TIR within the waveguides 202, 204, 206, respectively. The light rays 218, 219, 220 then impinge on the light distributing elements 210, 212, 214, respectively. The light distributing elements 210, 212, 214 deflect the light rays 218, 219, 220 so that they propagate towards the outcoupling optical elements 222, 224, 226, respectively.

In some embodiments, the light distributing elements 210, 212, 214 are orthogonal pupil expanders (OPEs). In some embodiments, the OPEs deflect or distribute light to the outcoupling optical elements 222, 224, 226 and, in some embodiments, may also increase the beam or spot size of this light as it propagates to the outcoupling optical elements. In some embodiments, the light distributing elements 210, 212, 214 may be omitted and the incoupling optical elements 203, 205, 207 may be configured to deflect light directly to the outcoupling optical elements 222, 224, 226. For example, with reference to FIG. 2A, the light distributing elements 210, 212, 214 may be replaced with outcoupling optical elements 222, 224, 226, respectively. In some embodiments, the outcoupling optical elements 222, 224, 226 are exit pupils (EPs) or exit pupil expanders (EPEs) that direct light to the eye of the user. It will be appreciated that the OPEs may be configured to increase the dimensions of the eye box in at least one axis and the EPEs may be configured to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EPE again, at which time another portion of the impinging light is directed out of the waveguide, and so on. Consequently, a single beam of in-coupled light may be “replicated” each time a portion of that light is redirected by an OPE or EPE, thereby forming a field of cloned beams of light. In some embodiments, the OPE and/or EPE may be configured to modify a size of the beams of light. In some embodiments, the functionality of the light distributing elements 210, 212, and 214 and the outcoupling optical elements 222, 224, 226 are combined in a combined pupil expander as discussed in relation to FIG. 2E.

Accordingly, with reference to FIGS. 2A and 2B, in some embodiments, the set 200 of waveguides includes waveguides 202, 204, 206; incoupling optical elements 203, 205, 207; light distributing elements (e.g., OPEs) 210, 212, 214; and outcoupling optical elements (e.g., EPs) 222, 224, 226 for each component color. The waveguides 202, 204, 206 may be stacked with an air gap/cladding layer between each one. The incoupling optical elements 203, 205, 207 redirect or deflect incident light (with different incoupling optical elements receiving light of different wavelengths) into its waveguide. The light then propagates at an angle which will result in TIR within the respective waveguide 202, 204, 206. In the example shown, light ray 218 (e.g., blue light) is deflected by the first incoupling optical element 203, and then continues to bounce down the waveguide, interacting with the light distributing element (e.g., OPEs) 210 and then the outcoupling optical element (e.g., EPs) 222, in a manner described earlier. The light rays 219 and 220 (e.g., green and red light, respectively) will pass through the waveguide 202, with light ray 219 impinging on and being deflected by incoupling optical element 205. The light ray 219 then bounces down the waveguide 204 via TIR, proceeding on to its light distributing element (e.g., OPEs) 212 and then the outcoupling optical element (e.g., EPs) 224. Finally, light ray 220 (e.g., red light) passes through the waveguide 206 to impinge on the light incoupling optical elements 207 of the waveguide 206. The light incoupling optical elements 207 deflect the light ray 220 such that the light ray propagates to light distributing element (e.g., OPEs) 214 by TIR, and then to the outcoupling optical element (e.g., EPs) 226 by TIR. The outcoupling optical element 226 then finally out-couples the light ray 220 to the viewer, who also receives the outcoupled light from the other waveguides 202, 204.

FIG. 2C illustrates a top-down plan view of an example of the stacked waveguides of FIGS. 2A and 2B. As illustrated, the waveguides 202, 204, 206, along with each waveguide's associated light distributing element 210, 212, 214 and associated outcoupling optical element 222, 224, 226, may be vertically aligned. However, as discussed herein, the incoupling optical elements 203, 205, 207 are not vertically aligned; rather, the incoupling optical elements are preferably nonoverlapping (e.g., laterally spaced apart as seen in the top-down or plan view). As discussed further herein, this nonoverlapping spatial arrangement facilitates the injection of light from different resources into different waveguides on a one-to-one basis, thereby allowing a specific light source to be uniquely coupled to a specific waveguide. In some embodiments, arrangements including nonoverlapping spatially separated incoupling optical elements may be referred to as a shifted pupil system, and the incoupling optical elements within these arrangements may correspond to sub pupils.

FIG. 2D is a simplified illustration of an eyepiece waveguide having a combined pupil expander according to an embodiment of the present invention. In the example illustrated in FIG. 2D, the eyepiece 270 utilizes a combined OPE/EPE region in a single-side configuration. Referring to FIG. 2D, the eyepiece 270 includes a substrate 272 in which in-coupling optical element 274 and a combined OPE/EPE region 276, also referred to as a combined pupil expander (CPE), are provided. Incident light ray 280 is incoupled via the incoupling optical element 274 and outcoupled as output light rays 282 via the combined OPE/EPE region 276.

The combined OPE/EPE region 276 includes gratings corresponding to both an OPE and an EPE that spatially overlap in the x-direction and the y-direction. In some embodiments, the gratings corresponding to both the OPE and the EPE are located on the same side of a substrate 272 such that either the OPE gratings are superimposed onto the EPE gratings or the EPE gratings are superimposed onto the OPE gratings (or both). In other embodiments, the OPE gratings are located on the opposite side of the substrate 272 from the EPE gratings such that the gratings spatially overlap in the x-direction and the y-direction but are separated from each other in the z-direction (i.e., in different planes). Thus, the combined OPE/EPE region 276 can be implemented in either a single-sided configuration or in a two-sided configuration.

FIG. 2E illustrates an example of wearable display system 230 into which the various waveguides and related systems disclosed herein may be integrated. With reference to FIG. 2E, the display system 230 includes a display 232, and various mechanical and electronic modules and systems to support the functioning of that display 232. The display 232 may be coupled to a frame 234, which is wearable by a display system user 240 (also referred to as a viewer) and which is configured to position the display 232 in front of the eyes of the user 240. The display 232 may be considered eyewear in some embodiments. In some embodiments, a speaker 236 is coupled to the frame 234 and configured to be positioned adjacent the ear canal of the user 240 (in some embodiments, another speaker, not shown, may optionally be positioned adjacent the other ear canal of the user to provide stereo/shapeable sound control). The display system 230 may also include one or more microphones or other devices to detect sound. In some embodiments, the microphone is configured to allow the user to provide inputs or commands to the system 230 (e.g., the selection of voice menu commands, natural language questions, etc.), and/or may allow audio communication with other persons (e.g., with other users of similar display systems). The microphone may further be configured as a peripheral sensor to collect audio data (e.g., sounds from the user and/or environment). In some embodiments, the display system 230 may further include one or more outwardly directed environmental sensors configured to detect objects, stimuli, people, animals, locations, or other aspects of the world around the user. For example, environmental sensors may include one or more cameras, which may be located, for example, facing outward so as to capture images similar to at least a portion of an ordinary field of view of the user 240. In some embodiments, the display system may also include a peripheral sensor, which may be separate from the frame 234 and attached to the body of the user 240 (e.g., on the head, torso, an extremity, etc. of the user 240). The peripheral sensor may be configured to acquire data characterizing a physiological state of the user 240 in some embodiments. For example, the sensor may be an electrode.

The display 232 is operatively coupled by a communications link, such as by a wired lead or wireless connectivity, to a local data processing module which may be mounted in a variety of configurations, such as fixedly attached to the frame 234, fixedly attached to a helmet or hat worn by the user, embedded in headphones, or otherwise removably attached to the user 240 (e.g., in a backpack-style configuration, in a belt-coupling style configuration). Similarly, the sensor may be operatively coupled by a communications link, e.g., a wired lead or wireless connectivity, to the local processor and data module. The local processing and data module may comprise a hardware processor, as well as digital memory, such as non-volatile memory (e.g., flash memory or hard disk drives), both of which may be utilized to assist in the processing, caching, and storage of data. Optionally, the local processor and data module may include one or more central processing units (CPUs), graphics processing units (GPUs), dedicated processing hardware, and so on. The data may include data a) captured from sensors (which may be, e.g., operatively coupled to the frame 234 or otherwise attached to the user 240), such as image capture devices (such as cameras), microphones, inertial measurement units, accelerometers, compasses, GPS units, radio devices, gyros, and/or other sensors disclosed herein; and/or b) acquired and/or processed using remote processing module 252 and/or remote data repository 254 (including data relating to virtual content), possibly for passage to the display 232 after such processing or retrieval. The local processing and data module may be operatively coupled by communication links 238 such as via wired or wireless communication links, to the remote processing and data module 250, which can include the remote processing module 252, the remote data repository 254, and a battery 260. The remote processing module 252 and the remote data repository 254 can be coupled by communication links 256 and 258 to remote processing and data module 250 such that these remote modules are operatively coupled to each other and available as resources to the remote processing and data module 250. In some embodiments, the remote processing and data module 250 may include one or more of the image capture devices, microphones, inertial measurement units, accelerometers, compasses, GPS units, radio devices, and/or gyros. In some other embodiments, one or more of these sensors may be attached to the frame 234, or may be standalone structures that communicate with the remote processing and data module 250 by wired or wireless communication pathways.

With continued reference to FIG. 2E, in some embodiments, the remote processing and data module 250 may comprise one or more processors configured to analyze and process data and/or image information, for instance including one or more central processing units (CPUs), graphics processing units (GPUs), dedicated processing hardware, and so on. In some embodiments, the remote data repository 254 may comprise a digital data storage facility, which may be available through the internet or other networking configuration in a “cloud” resource configuration. In some embodiments, the remote data repository 254 may include one or more remote servers, which provide information, e.g., information for generating augmented reality content, to the local processing and data module and/or the remote processing and data module 250. In some embodiments, all data is stored and all computations are performed in the local processing and data module, allowing fully autonomous use from a remote module. Optionally, an outside system (e.g., a system of one or more processors, one or more computers) that includes CPUs, GPUs, and so on, may perform at least a portion of processing (e.g., generating image information, processing data) and provide information to, and receive information from, the illustrated modules, for instance, via wireless or wired connections.

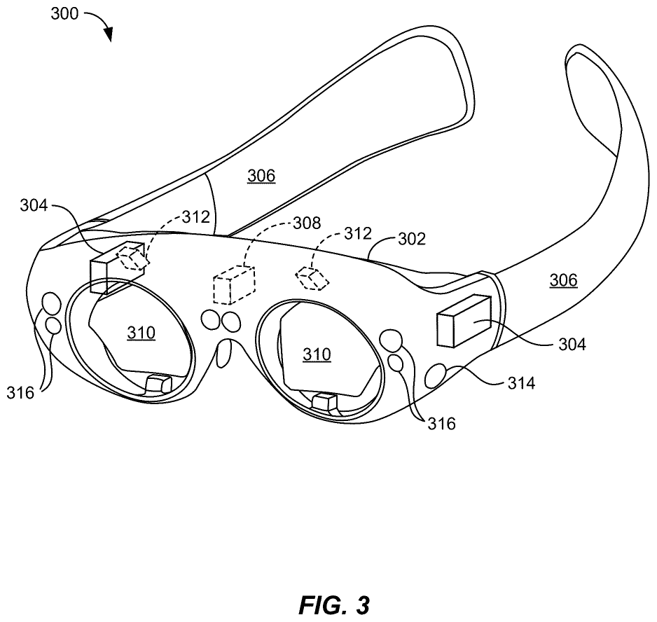

FIG. 3 shows a perspective view of a wearable device 300 according to an embodiment of the present invention. Wearable device 300 includes a frame 302 configured to support one or more projectors 304 at various positions along an interior-facing surface of frame 302, as illustrated. In some embodiments, projectors 304 can be attached at positions near temples 306. Alternatively, or in addition, another projector could be placed in position 308. Such projectors may, for instance, include or operate in conjunction with one or more liquid crystal on silicon (LCoS) modules, micro-LED displays, or fiber scanning devices. In some embodiments, light from projectors 304 or projectors disposed in positions 308 could be guided into eyepieces 310 for display to eyes of a user. Projectors placed at positions 312 can be somewhat smaller on account of the close proximity this gives the projectors to the waveguide system. The closer proximity can reduce the amount of light lost as the waveguide system guides light from the projectors to eyepiece 310. In some embodiments, the projectors at positions 312 can be utilized in conjunction with projectors 304 or projectors disposed in positions 308. While not depicted, in some embodiments, projectors could also be located at positions beneath eyepieces 310. Wearable device 300 is also depicted including sensors 314 and 316. Sensors 314 and 316 can take the form of forward-facing and lateral-facing optical sensors configured to characterize the real-world environment surrounding wearable device 300.

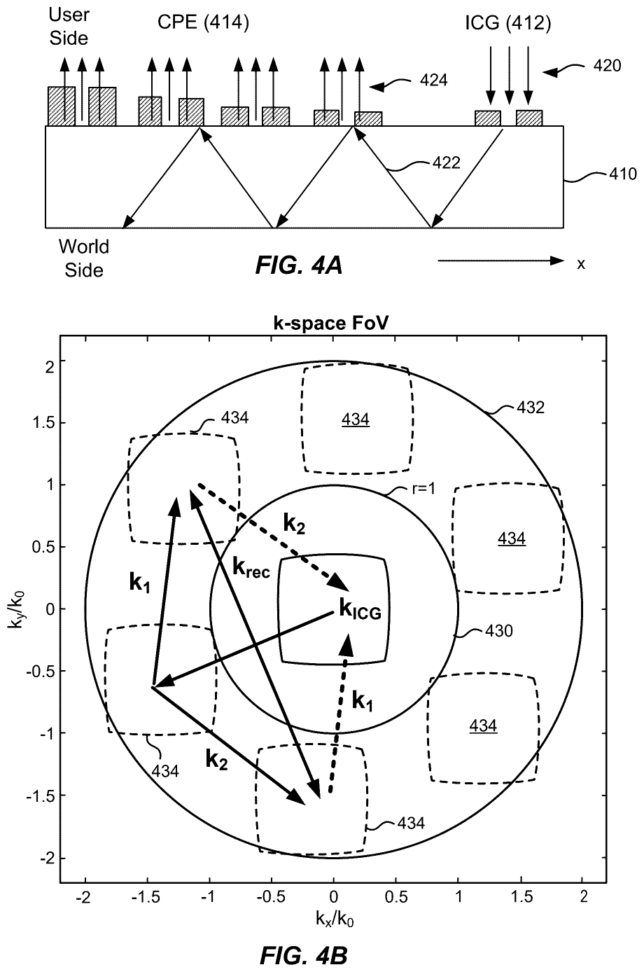

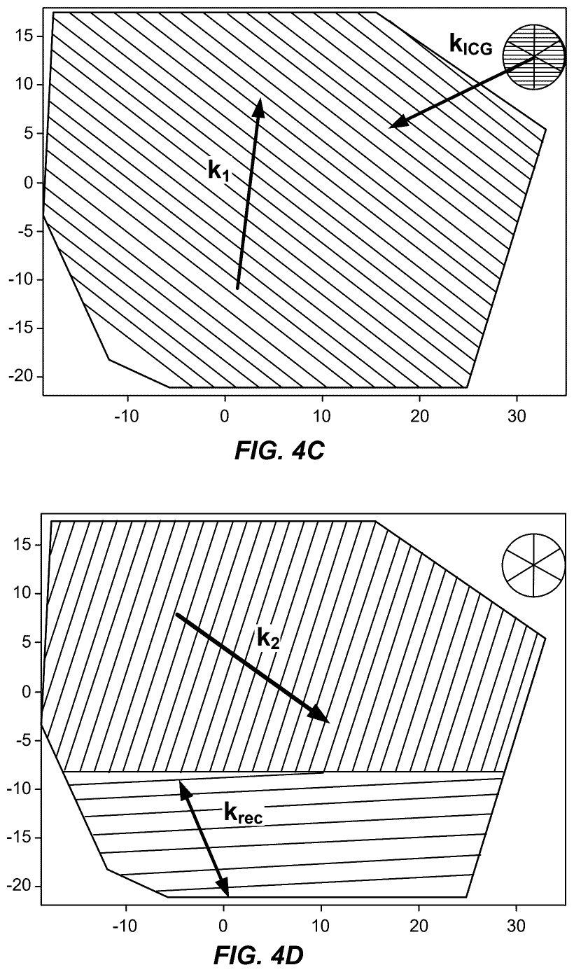

FIGS. 4A-4D illustrate the basic functioning of an eyepiece waveguide in which the input coupling grating (ICG) couples the light from the projector into the high index of refraction medium (e.g., glass) of the eyepiece waveguide.

FIG. 4A is a simplified cross-sectional diagram illustrating elements of an eyepiece waveguide according to an embodiment of the present invention. Referring to FIG. 4A, the diffractive and refractive properties of the waveguide can be discussed in the context of an AR display. Input light 420 generated by the projector is coupled into waveguide 410, which can also be referred to as an eyepiece waveguide, using an incoupling interface including a diffractive optical element, implemented in this embodiment, as an incoupling grating (ICG) 412. Waveguide 410 is implemented in the embodiment illustrated in FIG. 4A as a high index of refraction glass (n=2.0). Although n=2.0 in this embodiment, this is merely exemplary and waveguides with other refractive indices can be utilized according to embodiments of the present invention. The light incoupled at the incoupling interface propagates inside waveguide 410 as total internal reflection (TIR) light 422. An outcoupling interface including a diffractive optical element, implemented in this embodiment, as a combined pupil expander (CPE) 414, is provided. The CPE 414 includes a combination of diffraction gratings that spread the TIR light 422 over a large area of the eyepiece (extending into the plane of the figure as well as horizontally in the figure) as well as couple the light out of waveguide 410, illustrated as output light 424, at the same angle as the angle of incidence of the input light 420. Output light 424 is then viewable by a user.

In the illustrated embodiment, the grating depth in the CPE varies as a function of lateral position, i.e., the x-direction, increasing as the distance from ICG 412 increases, and thereby increasing the grating coupling efficiency as a function of lateral position. In other embodiments, the grating depth or other grating parameters related to grating strength is constant as a function of lateral position. Thus, both varying grating parameters and constant grating parameters are included within the scope of the present invention. Moreover, although figures herein do not represent varying grating parameters, e.g., varying grating depth, it will be understood that the grating parameters can vary in the embodiments described herein.

FIG. 4B is a simplified k-space diagram illustrating the field of view and grating vectors for an eyepiece waveguide according to an embodiment of the present invention. Referring to FIG. 4B, the k-space diagram can be used to understand the flow of light using this momentum space representation. As shown in FIG. 4B, the inner circle with radius=1 indicates momentum of light at all physically possible angles of incidence in free space or vacuum. The outer circle 432 of radius=index of refraction of glass (in this case, n=2) indicates all physically possible angles of incidence inside the eyepiece waveguide medium (e.g., glass). The field of view (FOV) corresponding to the projector is described by the extent of the barrel-shaped boxes 434 shown in FIG. 4B. Thus, the coupled or launched light into the glass has momentum that lies in the annular region in momentum space (i.e., between the inner r=n=1 circle and the outer r=n=2 circle) and, due to total internal reflection, this light will not escape from the eyepiece waveguide unless and until the light interacts with a diffraction grating that changes the momentum. For light incoupled into the waveguide via ICG 412, the FOV corresponding to the projector (e.g., an FOV of 53° (H)×53° (V)) will be shifted in k-space as represented by vector k_{ICG}.

The grating vectors in the k-space representation shown in FIG. 4B indicate not only the direction, i.e., the grating orientation, but also the pitch or grating periodicity for a given design wavelength. For instance, for an eyepiece waveguide designed specifically for the green wavelength of 525 nm, the k-space representation shown in FIG. 4B has a launch vector of k_{ICG}=1.5, which corresponds to one-dimensional gratings of pitch=525 nm/1.5=350 nm.

The grating region corresponding to the incoupling interface (i.e., ICG 412) has one-dimensional gratings defined by momentum translations of k_{ICG} as illustrated in FIG. 4B. For a CPE with 1D, binary, square-ridge gratings, the diffraction vectors k₁ and k₂ are defined by momentum translations of k₁ and k₂. k_{ICG}, k₁, and k₂ are shown as solid arrows in FIG. 4B since they correspond to incoupling into the waveguide and propagation in the waveguide. The diffraction of light propagating in the eyepiece waveguide by these diffraction gratings allows one to spread the launched light over a larger area, e.g., for exit pupil expansion. At the same time, these gratings also outcouple the spreading light, which corresponds to momentum translation shown by the dashed vectors in FIG. 4B. This outcoupled light is seen by the user's eye and, subsequently, the digital content can be observed. Because the eyepiece waveguide can have two sided patterns (i.e., facing both the user and the outside world), implementations can use either 2D gratings on one side of the eyepiece waveguide, with these 2D gratings defined by momentum translations k₁ and k₂, or 1D gratings, each formed on one side of the two sides of the eyepiece waveguide. Additional diffraction gratings, such as the one represented by momentum translation by k_{rec}, can also be introduced to improve the performance of AR display. Introduction of additional gratings is constrained by the requirement that the momentum translation has to be a linear integer combination of k₁ and k₂, otherwise it leads to double images.

It should be noted that, referring to the k-space diagram illustrated in FIG. 4B, light corresponding to the FOV that is not overlapping with the annular region between r=n=1 and r=n=2 will not propagate by TIR. Accordingly, only the portion of the FOV overlapping with the annular region will be accessible to the user.

FIG. 4C is a simplified plan view of the world side of an eyepiece waveguide according to an embodiment of the present invention. Referring to FIG. 4C, light incoupled by ICG 412 propagates as illustrated by vector k_{ICG} toward the CPE including a grating structure, i.e., the CPE is a diffractive optical element. In this embodiment, the grating depth can increase from a first value in the upper right corner of the eyepiece waveguide to a larger value in the lower left corner of the eyepiece waveguide. The grating variation can be continuous, stepped, or the like. The world side of the CPE includes gratings defined by grating vector k₁, which diffracts the light toward the upper left portion of the CPE.

FIG. 4D is a simplified plan view of the user side of the eyepiece waveguide shown in FIG. 4C. As discussed in relation to FIG. 4C, the grating depth in region 430 can increase from a first value on the right side of the eyepiece waveguide to a larger value on the left side of the eyepiece waveguide. The user side of the CPE includes gratings defined by grating vector k₂ in region 430, which diffracts the light toward the lower side of the CPE and k_{rec} in region 440, which diffracts light back toward region 430 to provide a light recycling function. The grating vector k_{rec} associated with this “recycling” grating is illustrated in FIG. 4B.

Referring to FIGS. 4C and 4D concurrently, light propagating in the eyepiece waveguide can be diffracted as represented by grating vectors k₁ and k₂ in order to spread in the eyepiece waveguide as illustrated by the solid vectors k₁ and k₂ in FIG. 4B. Additionally, light can also be diffracted as represented by grating vectors k₁ and k₂ in order to outcouple toward the user as illustrated by the dashed vectors k₁ and k₂ in FIG. 4B. The periodicity for the CPE gratings coupled to the world side and the user side can be equal, with different orientations although this is not required. Thus, as illustrated in FIG. 4C, diffraction gratings on the world side of the waveguide produce momentum translations k_{ICG} and k₁, whereas, as shown in FIG. 4D, diffraction gratings on the user side of the waveguide produce momentum translation k_{rec} and k₂. Although this diffraction grating layout is illustrated, other diffraction grating layouts can be utilized in accordance with embodiments of the present invention. One of ordinary skill in the art would recognize many variations, modifications, and alternatives.

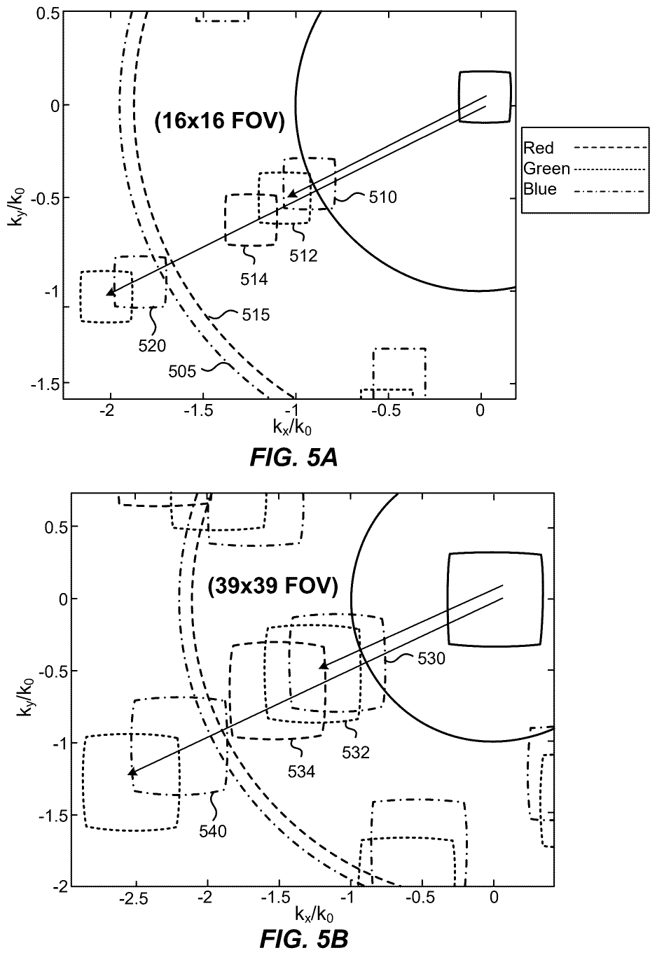

FIG. 5A is a simplified k-space diagram illustrating the field of view and ICG grating vectors for an eyepiece waveguide with a 16°×16° field of view according to an embodiment of the present invention. The k-space representation of this implementation of an eyepiece waveguide in which there is a single direction launch (i.e., unilaunch) and diffractive structures on both the world side and the user side of the eyepiece waveguide (i.e., multicombiner) is shown in FIG. 5A. For this eyepiece waveguide, the substrate has an index of refraction of 1.95 at 455 nm (i.e., a blue wavelength). Incoupling resulting from first order diffraction produces blue FOV 510, green FOV 512, and red FOV 514. As illustrated, a portion of blue FOV 510, i.e., the inner top portion, is clipped since light in this portion of the field of view is not supported by the eyepiece waveguide. Incoupling resulting from second order diffraction produces blue FOV 520. Similar to the clipping experienced by blue FOV 510, a portion of blue FOV 520, i.e., the outer bottom portion, is clipped since light in this portion of the field of view is not supported by the eyepiece waveguide.

FIG. 5B is a simplified k-space diagram illustrating the field of view and ICG grating vectors for an eyepiece waveguide with a 39°×39° field of view according to an embodiment of the present invention. For this eyepiece waveguide, the substrate has an index of refraction of 2.2 at 455 nm. Incoupling resulting from first order diffraction produces blue FOV 530, green FOV 532, and red FOV 534. As illustrated, a portion of blue FOV 530, i.e., the inner top portion, is clipped since light in this portion of the field of view is not supported by the eyepiece waveguide. Incoupling resulting from second order diffraction produces blue FOV 540. Similar to the clipping experienced by blue FOV 530, a portion of blue FOV 540, i.e., the outer bottom portion, is clipped since light in this portion of the field of view is not supported by the eyepiece waveguide.

As shown in FIGS. 5A and 5B, and as described more fully herein, the use of a substrate with a higher index of refraction supports incoupling of blue light in both the first diffraction order and the second diffraction order, also referred to as first order and second order launch.

According to embodiments of the present invention, a unilaunch, multicombiner eyepiece waveguide is able to launch blue light towards the CPE via both first and second order diffraction at the ICG.

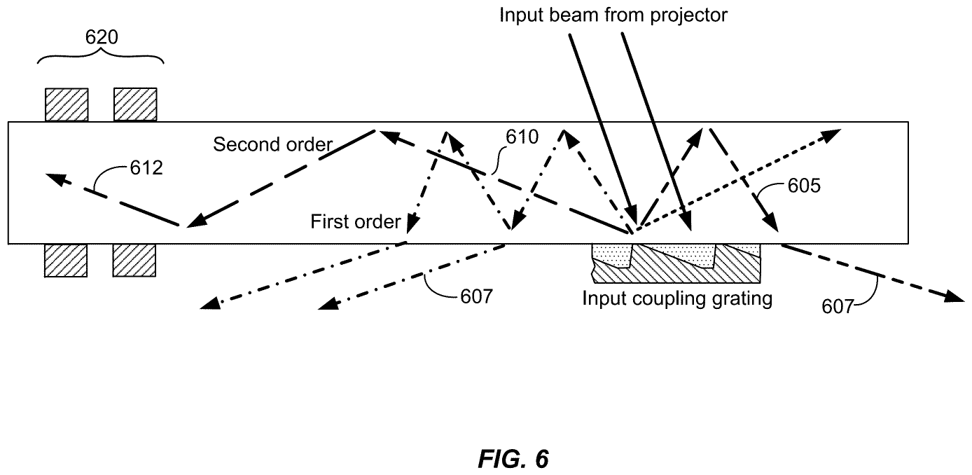

FIG. 6 is a simplified ray tracing diagram illustrating first order diffraction of input light and second order diffraction of blue light according to an embodiment of the present invention. Referring once again to FIG. 5B, the light rays corresponding to the temple portion of the k-space FOV (i.e., the right portions of blue FOV 510 and blue FOV 520 for a 16×16 FOV in FIG. 5A and the right portions of blue FOV 530 and blue FOV 540 for a 39×39 FOV in FIG. 5B) contain both first order and second order diffracted rays. However, the first order diffraction does not lead to the TIR condition and these light rays escape the waveguide near the ICG, as shown in the ray-tracing diagram shown in FIG. 6.

Referring to FIG. 6, light rays at blue wavelengths (i.e., blue light) is launched into the waveguide via both first and second diffraction orders. The first order light rays 605 bounce more frequently and are also not TIR modes of the waveguide. As a result, these rays escape the waveguide very early on as illustrated by rays 607, while the second order light rays 610 continue to travel towards the CPE 620 as TIR light rays 612.

Thus, based on the k-space representation and the ray-tracing diagram of the first-order loss of light, it follows that in order to support the full FOV with the waveguide, the portion of the FOV launched as second order diffracted light can be larger than the portion of the FOV that is cut-off after launch as first order diffracted light (i.e., non-TIR light). Using this condition, the inventors have analyzed the maximum FOV supported by the unilaunch multicombiner eyepiece waveguide and the dependence on the index of refraction of the substrate.

Interestingly, the embodiments described herein operate at high index of refraction values, for example, index of refraction n≥2.0. For instance, FIG. 5A shows that a 16×16 FOV may not be supported by an n=1.95 waveguide (i.e., ring 505) because the loss of the blue FOV portion upon first order launch is larger than the gain of the FOV portion via second order diffraction. As illustrated in FIGS. 5A and 5B, additional ring 515 corresponding to the index of refraction at red wavelengths is shown, which is a consideration in calculating the FOV at high index values such as n=2.2 shown in FIG. 5B. Thus, embodiments of the present invention enable the full FOV to be supported, not only for blue wavelengths, but also for red and green wavelengths. For this example, the wavelengths are 455 nm, 525 nm, and 628 nm.

Table 1 lists the maximum FOV supported for increasing values of index of refraction at blue wavelengths (i.e., 455 nm) using the unilaunch multicombiner eyepiece waveguide described herein, compared to a conventional design that utilizes the launch of only first order diffracted light into the waveguide. As illustrated in FIGS. 5A and 5B, at n=1.95 and below, eyepiece waveguides using both first and second order diffraction support a much smaller FOV (e.g., 13°×13° FOV) than eyepiece waveguides relying only on first order diffraction (e.g., 20°×20° FOV). Thus, embodiments of the present invention are particularly useful for index of refraction values above n=2.05. Without limiting embodiments of the present invention, the inventors believe that this dependence results from the nonlinear dependence of how the first order and second order fields of view are accommodated within the annulus.

TABLE 1

| Index of | FOV supported by | FOV supported |
|---|---|---|
| refraction at 455 | combining 1^{st} and 2^{nd} | based on only 1^{st} |
| nm (blue) | order launch | order launch |
| 1.95 | 13° (H) × 13° (V) | 20° (H) × 20° (V) |
| 2.0 | 22° (H) × 22° (V) | 22° (H) × 22° (V) |
| 2.05 | 24° (H) × 24° (V) | 23° (H) × 23° (V) |
| 2.1 | 27° (H) × 27° (V) | 25° (H) × 25° (V) |
| 2.15 | 34° (H) × 34° (V) | 27° (H) × 27° (V) |
| 2.2 | 39° (H) × 39° (V) | 30° (H) × 30° (V) |
| 2.25 | 44° (H) × 44° (V) | 33° (H) × 33° (V) |
| 2.3 | 47° (H) × 47° (V) | 36° (H) × 36° (V) |
| 2.35 | 49° (H) × 49° (V) | 38° (H) × 38° (V) |
| 2.4 | 52° (H) × 52° (V) | 40° (H) × 40° (V) |

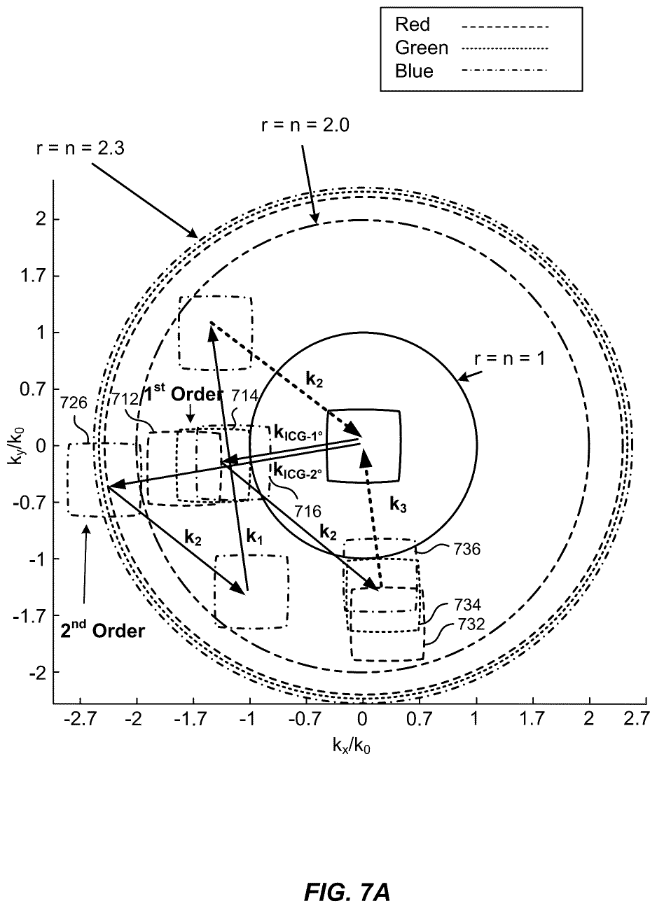

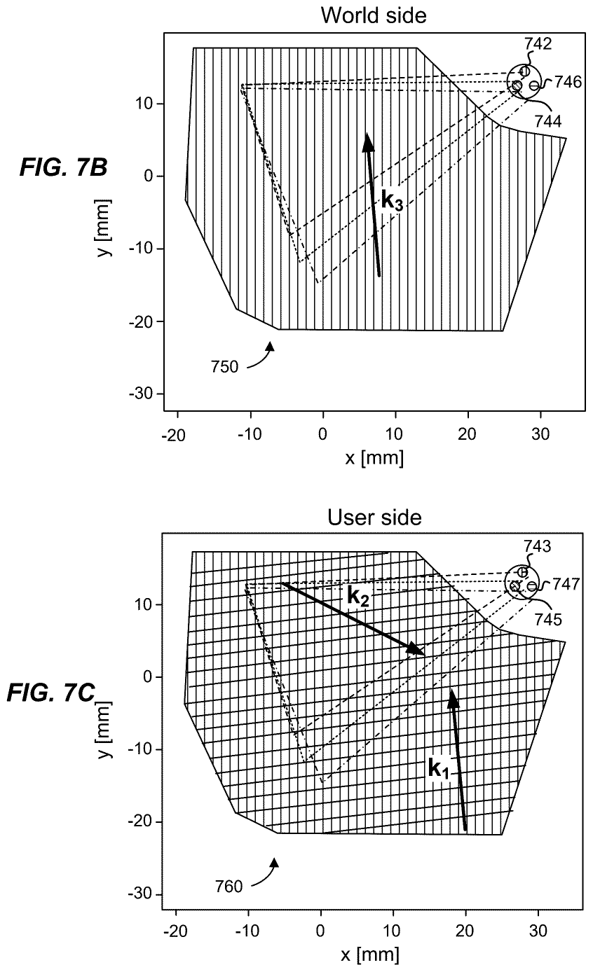

In relation to FIGS. 7A-7C, k-space representations of ICG gratings and CPE gratings, as well as CPE layouts showing the locations of respective gratings for different multiple diffraction order waveguide architectures, are illustrated. Additionally, the minimal sequence of diffraction events that direct the projector light at red, green, or blue wavelength to the user's eye is discussed. The k-space representations are for a 53° (H)×53° (V) FOV with an eyepiece waveguide with an index of refraction of n=2.3 and three separate ICG pupils for red, green, and blue wavelengths. The grating vectors are normalized with respect to green free-space momentum.

The reference to “an index of refraction of n=2.3” is, in actuality, a reference to a nominal value for the index of refraction since the eyepiece waveguide, also referred to as a substrate, is dispersive. Because the eyepiece waveguide is characterized by dispersion, a set of circles corresponding to a substrate with an index of refraction is illustrated for the r=n=2.3 circle. Since, due to dispersion, the index of refraction for blue light (e.g., the wavelength range of ~400 nm to ~500 nm) is higher than the index of refraction for green light, (e.g., the wavelength range of ~500 nm to ~500 nm), which is higher than the index of refraction for red light, (e.g., the wavelength range of ~600 nm to ~700 nm), the r=n=2.3 circle for blue light is larger than the r=n=2.3 circle for green light, which is larger than the r=n=2.3 circle for red light. Thus, the reference to a “r=n=2.3 circle” is intended to represent the actual index of refraction as a function of wavelength. The r=n=2.0 circle corresponds to the index of refraction for blue light. One of ordinary skill in the art would recognize many variations, modifications, and alternatives.

FIG. 7A is a simplified k-space diagram illustrating the field of view, ICG grating vectors, and CPE grating vectors for an eyepiece waveguide with multiple diffraction orders according to an embodiment of the present invention. FIG. 7B is a simplified plan of the world side of an eyepiece waveguide with multiple diffraction orders according to an embodiment of the present invention. FIG. 7C is a simplified plan of the user side of an eyepiece waveguide with multiple diffraction orders according to an embodiment of the present invention.

Referring first to FIGS. 7B and 7C, this first eyepiece waveguide utilizes a unidirectional launch eyepiece waveguide design in which separate ICG pupils coupled to the world side of the eyepiece waveguide, illustrated as red ICG 742, also referred to a red subpupil, green ICG 744, also referred to a red subpupil, and blue ICG 746, also referred to a red subpupil, in FIG. 7B, are utilized in conjunction with red ICG 743, green ICG 745, and blue ICG 747 coupled to the user side of the eyepiece waveguide as shown in FIG. 7C. Thus, light from the projector is coupled into the eyepiece waveguide using these six ICGs. However, as discussed more fully below, the grating periodicity for the various ICGs and the corresponding grating vectors, which are designed with respect to a green wavelength, are different for blue light (and the blue ICGs) as compared to red and green light (and the red and green ICGs). Although the embodiment illustrated in FIG. 7C includes red ICG 743, green ICG 745, and blue ICG 747 coupled to the user side of the eyepiece waveguide, this is not required and, in some embodiments, red ICG 743, green ICG 745, and blue ICG 747 are optional.

Referring to FIG. 7A, grating vector k_{ICG-1°} represents first order (i.e., 1°) diffraction in k-space and grating vector k_{ICG-2°} represents second order (i.e., 2°) diffraction in k-space. Thus, for red ICG 742 and green ICG 744 coupled to the world side of the eyepiece waveguide or red ICG 743 and green ICG 745 coupled to the user side of the eyepiece waveguide, light at the center of the FOV is diffracted in the first order into the eyepiece waveguide as represented by grating vector k_{ICG-1°} to produce red FOV 712 for red wavelengths and green FOV 714 for green wavelengths. Both red FOV 712 and green FOV 714 are positioned within the annular region between r=n=1 and r=n=2.

Light diffracted into the eyepiece waveguide using blue ICG 746 coupled to the world side of the eyepiece waveguide or blue ICG 747 coupled to the user side of the eyepiece waveguide also diffracts in the first order as represented by grating vector k_{ICG-1°}. Thus, for blue ICG 746 coupled to the world side and blue ICG 747 coupled to the user side of the eyepiece waveguide, light at the center of the FOV is diffracted in the first order into the eyepiece waveguide to produce blue FOV 716 for blue wavelengths. This FOV is partially positioned within the annular region between r=n=1 and r=n=2, with the inner portion of the FOV adjacent the r=n=1 circle. Accordingly, this wavelength-specific, multi-directional launch architecture enables a full 53° (H)×53° (V) FOV for first order diffraction for red and green wavelengths because the respective barrel-shaped boxes corresponding to red FOV 712 and green FOV 714, which correspond to TIR light, lie entirely within the annular region between r=n=1 and r=n=2. However, for first order diffraction for blue wavelengths, the respective barrel-shaped box corresponding to blue FOV 716, which corresponds to TIR light, only lies partially within the annular region between r=n=1 and r=n=2. As a result, propagation of a portion of blue FOV 716 (i.e., the nasal portion) is not supported by the eyepiece waveguide and the nasal portion of blue FOV 716 inside the r=n=1 circle is clipped to form a partial field of view that lacks the nasal portion, also referred to as a nasal region.

Referring to FIG. 7B, the orientation of the gratings in red ICG 742, green ICG 744, and blue ICG 746, as well as red ICG 743, green ICG 745, and blue ICG 747, are oriented such that red, green, and blue light is launched into the eyepiece waveguide region of the CPE 750, also referred to a CPE diffractive optical element, on the world side and toward the CPE 760 on the user side.

Referring to FIG. 7C, red light and green light that is launched toward CPE 760 impinges on gratings corresponding to grating vector k₂, thereby diffracting in the plane of the eyepiece waveguide (i.e., laterally in the eyepiece waveguide). As a result, red FOV 712 shifts in k-space to red FOV 732, green FOV 714 shifts in k-space to green FOV 734, and blue FOV 716 shifts in k-space to blue FOV 736, which is also only partially supported by the waveguide, i.e., propagates by TIR in the waveguide. Diffraction in CPE 750 from gratings corresponding to grating vector k₃ results in outcoupling from the eyepiece waveguide.

Referring once again to FIG. 7A, the eyepiece waveguide is not only able to support first order diffraction, but also second order diffraction of shorter wavelengths. Accordingly, light diffracted in the second order into the eyepiece waveguide using blue ICG 746 coupled to the world side of the eyepiece waveguide or blue ICG 747 coupled to the user side of the eyepiece waveguide also diffracts in the second order as represented by grating vector k_{ICG-2°}. Thus, for blue ICG 746 coupled to the world side and blue ICG 747 coupled to the user side of the eyepiece waveguide, light at the center of the FOV is diffracted in the second order into the eyepiece waveguide to produce blue FOV 726 for blue wavelengths. This FOV is partially positioned within the annular region between r=n=1 and r=n=2.3, with the outer portion of the FOV adjacent the r=n=2.3 circle. In a manner complementary to the clipped nasal portion of blue FOV 716 diffracted into the eyepiece waveguide in the first order, propagation of a portion of blue FOV 726 (i.e., the temple portion) is not supported by the eyepiece waveguide and the temple portion of blue FOV 726 is clipped to form a partial field of view that lacks the temple portion, also referred to as a temple region.

Thus, second order diffraction of the shorter wavelength color, in combination with an eyepiece waveguide fabricated using a material with a high index of refraction (e.g., n=2.3), which supports TIR of the shorter wavelength light diffracted into the eyepiece waveguide in the second order, form the portion of the field of view (i.e., the nasal portion) missing in the first order diffracted light.

Thus, in combination, the portion of blue FOV 716 diffracted into the eyepiece waveguide in the first order and supported by the eyepiece waveguide and the portion of blue FOV 726 diffracted into the eyepiece waveguide in the second order and supported by the eyepiece waveguide results in a full 53° (H)×53° (V) FOV for blue wavelengths. As shown in FIG. 7A, the portion of blue FOV 716 (i.e., first order diffraction) within the annular region between r=n=1 and r=n=2 and the portion of blue FOV 726 (i.e., second order diffraction) within the annular region between r=n=1 and r=n=2.3 overlap to form a combined field of view.

Blue light that is launched toward CPE 760 impinges on gratings corresponding to grating vector k₂ in CPE 760, thereby diffracting in the plane of the eyepiece waveguide. As a result, blue FOV 716 shifts in k-space to blue FOV 736 as shown in FIG. 7A. Diffraction from gratings corresponding to grating vector k₃ results in outcoupling from the eyepiece waveguide. Accordingly, the first order diffraction pathway for red, green and blue wavelengths (i.e., first partial blue FOV), which indicates the minimal sequence of the interaction with different grating types as the incident light propagates from the projector to the user's eye, is k_{ICG-1°}→k₂→k₃. The second order diffraction pathway for blue wavelengths (second partial blue FOV) is k_{ICG-2°}→k₂→k₁→k₂. The first partial blue FOV and the second partial FOV are complementary, with clipping of the inner portion of blue FOV 716 and clipping of the outer portion of blue FOV 726.

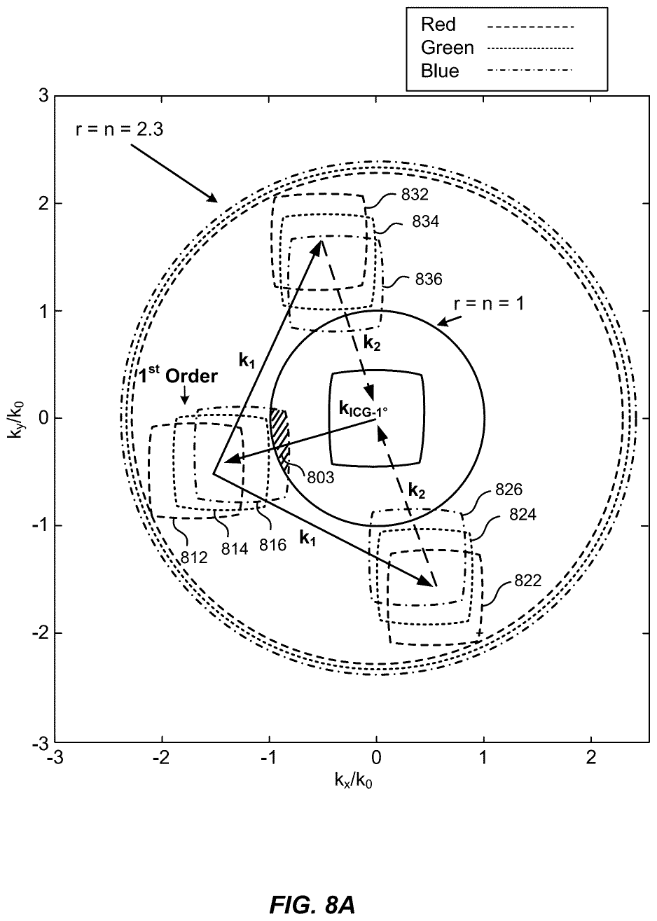

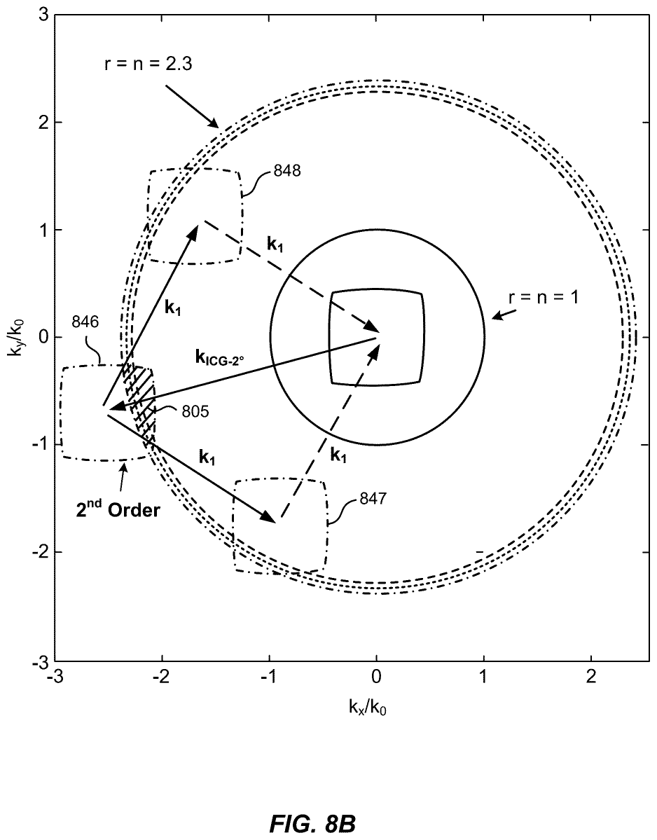

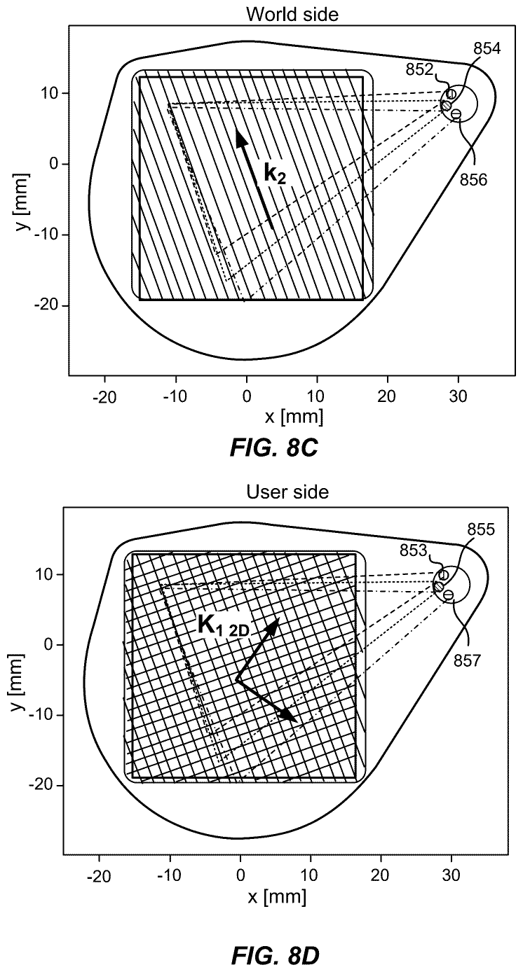

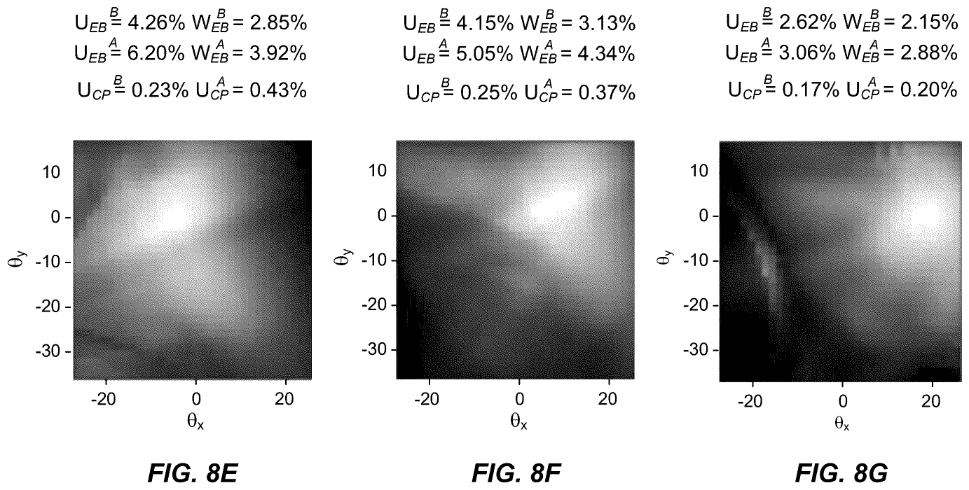

FIG. 8A is a simplified k-space diagram illustrating the field of view and ICG grating vectors for an eyepiece waveguide with one-dimensional and two-dimensional gratings and multiple diffraction orders according to an embodiment of the present invention. Grating vector k_{ICG-1°} represents first order (i.e., 1°) diffraction in k-space that produces red FOV 812 for red wavelengths, green FOV 814 for green wavelengths, and blue FOV 816 for blue wavelengths. Both red FOV 812 and green FOV 814 are positioned within the annular region between r=n=1 and r=n=2.3. However, a portion 803 of blue FOV 816 is clipped since this portion is not supported by the waveguide.

Diffraction in the plane of the eyepiece waveguide from gratings corresponding to grating vector k₁ on the user side of the eyepiece waveguide and oriented in a first direction (i.e., down and to the right) results in red FOV 812 shifting in k-space to red FOV 822, green FOV 814 shifting in k-space to green FOV 824, and blue FOV 816 shifting in k-space to blue FOV 826, which is also only partially supported by the waveguide, i.e., propagates by TIR in the waveguide. Concurrently, diffraction in the plane of the eyepiece waveguide from gratings corresponding to grating vector k₁ on the user side of the eyepiece waveguide and oriented in a second direction orthogonal to the first direction (i.e., up and to the right) results in red FOV 812 shifting in k-space to red FOV 832, green FOV 814 shifting in k-space to green FOV 834, and blue FOV 816 shifting in k-space to blue FOV 836, which is also only partially supported by the waveguide, i.e., propagates by TIR in the waveguide. Outcoupling results from diffraction from gratings corresponding to grating vector k₂ on the world side of the eyepiece waveguide.

FIG. 8B is a simplified k-space diagram illustrating the field of view and CPE grating vectors for an eyepiece waveguide with one-dimensional and two-dimensional gratings and multiple diffraction orders according to an embodiment of the present invention. Grating vector k_{ICG-2°} represents second order (i.e., 2°) diffraction in k-space that produces blue FOV 846 for blue wavelengths. Similar to blue FOV 816 shown in FIG. 8A, only complementary portion 805 of blue FOV 846 is supported by the waveguide, with the remainder of blue FOV 816 being positioned at a radius greater than the n=2.3 circle for blue light.

Diffraction in the plane of the eyepiece waveguide from gratings corresponding to grating vector k₁ on the user side of the eyepiece waveguide and oriented in a first direction (i.e., down and to the right) results in blue FOV 846 shifting in k-space to blue FOV 847, which is also only partially supported by the waveguide. Concurrently, diffraction in the plane of the eyepiece waveguide from gratings corresponding to grating vector k₁ on the user side of the eyepiece waveguide and oriented in a second direction orthogonal to the first direction (i.e., up and to the right) results in blue FOV 846 shifting in k-space to blue FOV 848, which is also only partially supported by the waveguide. Outcoupling results from diffraction from gratings corresponding to the two orthogonal grating vectors k₁ on the user side of the eyepiece waveguide.

Thus, in combination, portion 803 of blue FOV 816 is clipped, with the remaining portion of blue FOV 816 being diffracted into the eyepiece waveguide in the first order and supported by the eyepiece waveguide. In a complementary manner, complementary portion 805 of blue FOV 846 is not clipped, but diffracted into the eyepiece waveguide in the second order and supported by the eyepiece waveguide. Thus, the combined field of view is formed by the remaining portion of blue FOV 816 (i.e., blue FOV 816 minus portion 803) and complementary portion 805 of blue FOV 848 (i.e., the portion of blue FOV 848 supported by the eyepiece waveguide), resulting in a full 53° (H)×53° (V) FOV for blue wavelengths. As shown in FIGS. 8A and 8B, the remaining portion of blue FOV 816 (i.e., first order diffraction) within the annular region between r=n=1 and r=n=2 and the complementary portion 805 of blue FOV 816 (i.e., second order diffraction) within the annular region between r=n=1 and r=n=2.3 overlap to form a combined field of view. In some embodiments, the first portion occupies a first area of the field of view (i.e., the remaining portion of blue FOV 816) and the complementary portion 805 occupies a second area of the field of view that is greater than or equal to the first area. Thus, any blue light clipped from the field of view after first order diffraction is replaced by the remaining portion supported by the eyepiece waveguide after second order diffraction. In other words, the complementary portion occupies a larger area of the field of view than the first portion, thereby resulting in a full field of view.

FIG. 8C is a simplified plan of the world side of an eyepiece waveguide with one-dimensional and two-dimensional gratings and multiple diffraction orders according to an embodiment of the present invention. FIG. 8D is a simplified plan of the user side of an eyepiece waveguide with one-dimensional and two-dimensional gratings and multiple diffraction orders according to an embodiment of the present invention. The orientation of the gratings in red ICG 852, green ICG 854, and blue ICG 856 on the world side of the eyepiece waveguide, as well as red ICG 853, green ICG 855, and blue ICG 857 on the user side of the eyepiece waveguide, are oriented such that all three colors are launched into the eyepiece waveguide at the same range of angles. Thus, this design can be referred to as a unidirectional launch (unilaunch) design.

FIG. 8E is a plot of the eyebox efficiency for a red wavelength across the full field of view for an eyepiece according to an embodiment of the present invention. FIG. 8F is a plot of the eyebox efficiency for a green wavelength across the full field of view for an eyepiece according to an embodiment of the present invention. FIG. 8G is a plot of the eyebox efficiency for a blue wavelength across the full field of view for an eyepiece according to an embodiment of the present invention.

In FIGS. 8E-8G, the efficiency distribution across the full field of view normalized to its maximum value is shown. The KPIs indicated above each plot are as the following: U_{EB}^{B}, U_{EB}^{A}, U_{CP}^{B}, and U_{CP}^{A} denote the user side eyebox efficiency for zone B (full 53° (H)×53° (V) FOV), for zone A (30° (H) by 30° (V) FOV centered at the center of the eyebox), for the central exit pupil of the eyebox (e.g., a 4 mm diameter circle at the center of a 16 mm×16 mm eyebox) for zone B, and for the central exit pupil of the eyebox for zone A, respectively. The eyebox efficiency is the averaged (over the FOV) percentage of the incident light from the projector that hits the eyebox (a rectangular region capturing the potential eye positions with respect to the eyepiece for a large number of head models with different interpupillary distances) at a specific clearance distance, typically from 16 mm to 22 mm from the eyepiece. Similarly, W_{EB}^{B} and W_{EB}^{A} denote the efficiencies as observed from the world side.

In order to achieve incoupling of light in both the first and second diffraction orders, also referred to as first and second order launch, embodiments of the present invention can utilize ICGs that can efficiently launch both first and second order diffracted light into the waveguide. Thus, as described above, the second order diffracted blue light that is launched into the waveguide can be outcoupled using, for example, two different configurations, unidirectional launch or multidirectional launch in combination with a multi-combiner. The multi-combiner can use 2D grating or 1D gratings. Given these designs, embodiments of the present invention utilize ICG designs that are able to efficiently launch the second order diffracted light into the waveguide.

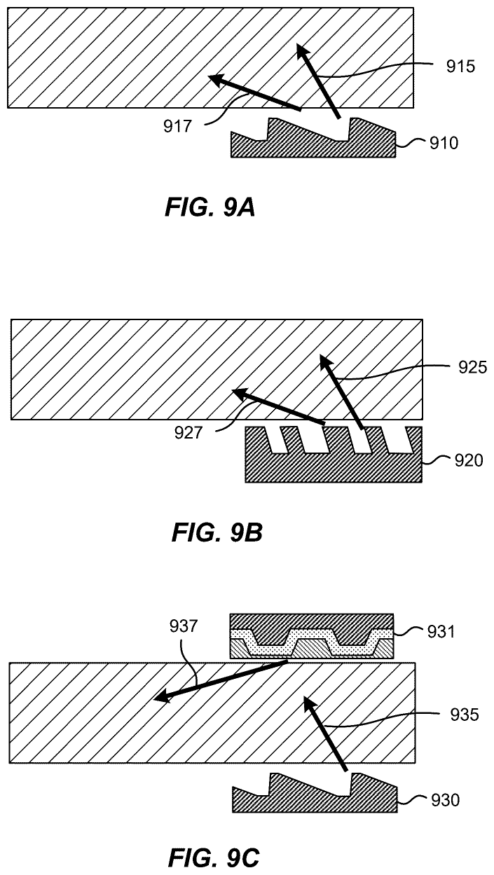

FIG. 9A is a simplified cross-sectional schematic diagram illustrating an etched grating (i.e., an ICG 910) supporting first order launch 915 and second order launch 917 according to an embodiment of the present invention. FIG. 9B is a simplified cross-sectional schematic diagram illustrating an etched metabinary grating 920 supporting first order launch 925 and second order launch 927 according to an embodiment of the present invention. FIG. 9C is a simplified cross-sectional schematic diagram illustrating a double-sided imprint grating 930/931 supporting first order launch 935 and second order launch 937 according to an embodiment of the present invention.

In general, metallized reflective ICGs provide the largest efficiency numbers over the large FOV. These reflective ICGs can be imprinted or they can be directly etched into the substrate or the coating on top of the substrate. The imprint index (n≤1.8) is typically lower than the substrate index (n≥2.0). For embodiments using high index substrates (n>=2.05), the imprint-based metallized reflective grating provides very low second-order diffraction. In order to achieve large second order diffraction, a higher grating index is utilized as explained in detail along with different implementations below.

As illustrated in FIG. 9B, the ICG can use metabinary gratings 920 that are defined as the gratings having two different shaped structures within the same period. These can come in a variety of different shapes and can be optimized further to provide efficient combined first and second order launch.

As illustrated in FIG. 9C, the ICG can use a metallized low-index imprint reflective grating 930 to launch the first diffraction order 935 along with an additional transmissive ICG 931 on the opposite side of the waveguide dedicated to launching the second diffraction order 937 and hence having half the pitch as the primary ICG. The half-pitch ICG can be an imprint grating coated with a high-index material or it can be etched into a high-index substrate/coating. The presence of high index material for the half-pitch secondary ICG is sufficient to provide reasonably strong second order diffraction.

The following section explores, in depth, how the ICG 910 shown in FIG. 9A can be implemented in several forms and the various considerations that go into the ICG design that are specific to a unilaunch multicombiner eyepiece waveguide.

One of the common types of ICG used for coupling into the waveguide is a blazed ICG. There can be also single or multiple coating layers of higher and lower index materials deposited on top the blazed grating.

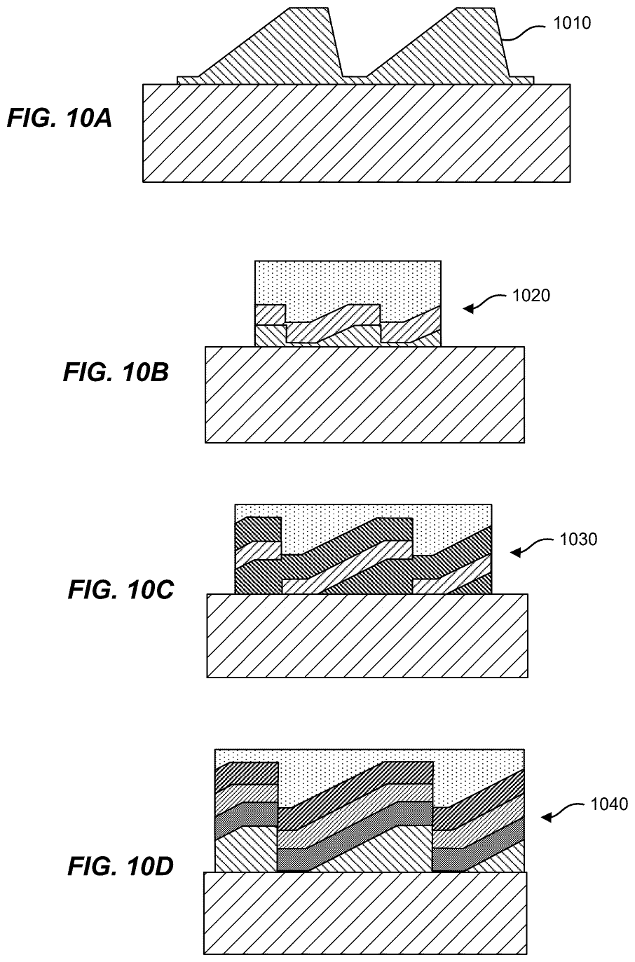

FIG. 10A is a simplified cross-sectional schematic diagram illustrating a metallic blazed grating 1010 for an ICG according to an embodiment of the present invention. FIG. 10B is a simplified cross-sectional schematic diagram illustrating a single layer metallic coated blazed grating 1020 for an ICG according to an embodiment of the present invention. FIG. 10C is a simplified cross-sectional schematic diagram illustrating a double layer coated blazed grating 1030 for an ICG according to an embodiment of the present invention. FIG. 10D is a simplified cross-sectional schematic diagram illustrating a coating with multiple dielectric layers on a blazed grating 1040 for an ICG according to an embodiment of the present invention.

As described in U.S. Provisional Patent Application No. 63/423,286, filed on Nov. 7, 2022, entitled “Polarization Insensitive Diffraction Grating and Display Including the Same,” which is hereby incorporated by reference, the use of a higher index coating layer to achieve a high efficiency, low back reflection ICG for unpolarized light was demonstrated. Thus, even in the absence of coating layers on top of the blazed ICGs, the first diffraction order and launch efficiency in the waveguide is already optimized for Transverse Magnetic/P polarization of light.

Without the loss of generality, here we show how the design space of a blazed ICG enables efficient launching of the second order diffracted light into the waveguide as well as achieving a uniform launch pattern across the desired FOV. In addition, the ratio of the power launched into these two orders can be tuned accordingly. The following demonstrates these principles for a simple blazed ICG and for TM polarization, but similar control and dependency can be also demonstrated for other waveguides. The analysis here will target a blue wavelength of close to 455 nm.

For this analysis, a blazed ICG with the parameters listed in Table 2 is assumed:

TABLE 2

| | Design | | Anti- | | | |
|---|---|---|---|---|---|---|
| K | Wave- | Blazed | blaze | Top | Bottom | |
| launch | length | Angle | Angle | Width | Width | Materials |
| 1.49 | 0.525 um | 28 deg | 80 deg | 0.1 μm | 0.06 μm | Resist, |
| | | | | | | Etched |
| | | | | | | into |
| | | | | | | Waveguide |
| | | | | | | or a higher |
| | | | | | | index layer |

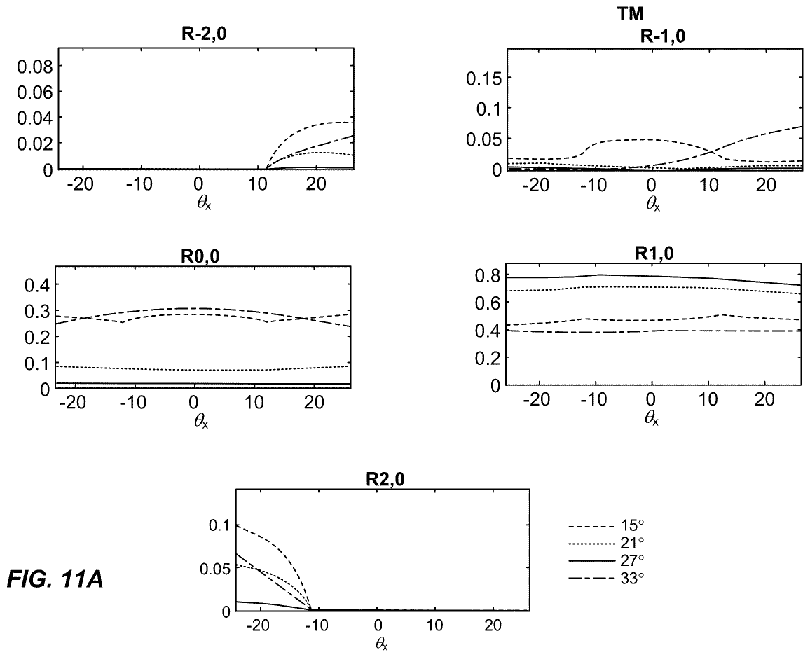

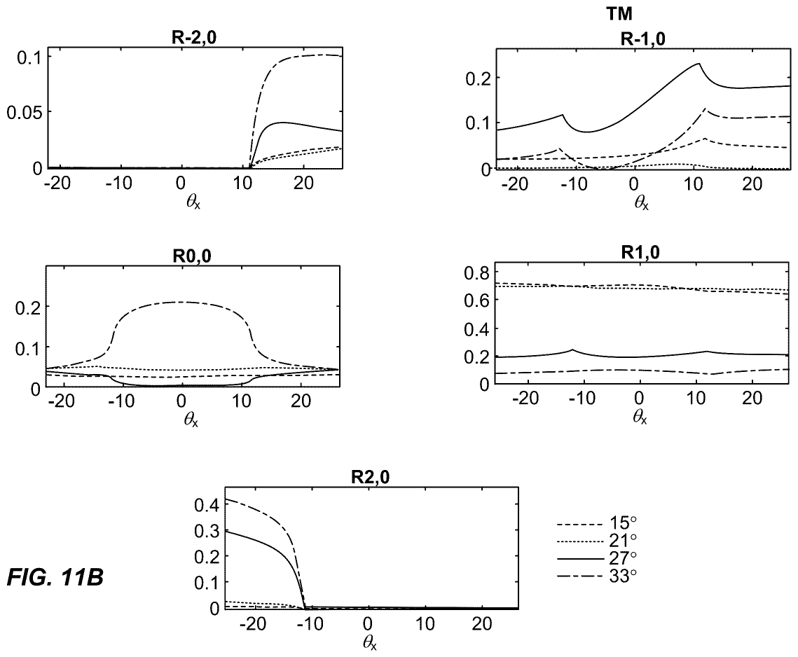

FIG. 11A illustrates diffraction orders for blue light calculated for various blazed angles across the horizontal FOV for an ICG with nano-imprinted photoresist diffractive structures according to an embodiment of the present invention.

FIG. 11B illustrates diffraction orders for blue light calculated for various blazed angles across the horizontal FOV for an ICG with diffractive structures etching into a lithium niobate substrate according to an embodiment of the present invention.

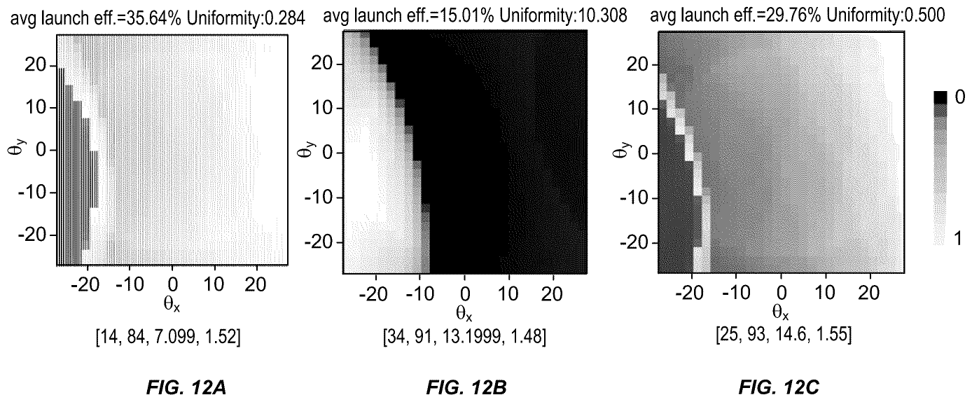

As shown in FIGS. 11A and 11B, by increasing the blazed angles from 15° to 33°, the power in the first diffraction order decreases for TM polarization while the power in the second diffraction order increases to slightly above 10% as shown in FIG. 11A and to more than 40% as shown in FIG. 11B. Lithium niobate in this case shows a larger second order response, which is more than four times that observed using nano-imprinted photoresist. The same trend is observed when the blazed ICG is realized using etching into a high index layer (i.e., an index smaller than LiNbO₃). Therefore, higher index ICGs realized by using lithium niobate or etched high index coated film facilitate the realization of a uniform launched pattern into the waveguide. As shown below in relation to FIGS. 12A-12C, the simulated launch efficiency for three different designs for a 53°×53° FOV are computed.

FIG. 12A is a plot of launch efficiency as a function of angle for a blazed ICG that couples efficiently into the first diffraction order according to an embodiment of the present invention. FIG. 12B is a plot of launch efficiency as a function of angle for a blazed ICG that couples efficiently into the second diffraction order according to an embodiment of the present invention. FIG. 12C is a plot of launch efficiency as a function of angle for a blazed ICG that couples efficiently into both the first diffraction order and the second diffraction order according to an embodiment of the present invention.

For the blazed ICGs corresponding to the efficiency plots in FIGS. 12A-12C, a blazed ICG grating was etched into a lithium niobate substrate. The blaze angle, anti-blaze angle, launch angle, and the launch vector are shown below each plot. As shown in FIGS. 12A-12C, by exploring the design space, diffraction gratings can be designed to launch in both diffraction orders. In this case, low blaze angles couple efficiently in the first diffraction order (R1,0) while larger blazed angle ICGs, corresponding to taller and/or thicker gratings, couple efficiently in the second diffraction order (R2,0), and a value in-between can be determined to launch the power into both diffraction orders.

It should be noted, as discussed more fully in relation to FIGS. 7A, 8A, and 8B, that the outcoupling mechanisms for the first order light and the second order light are different, corresponding to different grating vectors in k-space for outcoupling. Thus, utilizing the multicombiners discussed herein, there are different outcoupling paths as shown by grating vector k₃ for first order diffracted light and grating vector k₂ for second order diffracted light (see FIG. 7A) and grating vector k₂ for first order diffracted light (see FIG. 8A) and the 2D grating vector k₁ for second order diffracted light (see FIG. 8B). Hence, the ratio of the power launched into the eyepiece waveguide in the second diffraction order does not necessarily need to be equal to the power launched into eyepiece waveguide in the first diffraction order, yet the transition circle across the FOV between the two is preferably smooth in order to prevent discontinuity across the FOV.

The same analysis discussed above in relation to the metallic blazed grating for an ICG illustrated in FIG. 10A is shown below for the diffractive structures illustrated in FIGS. 10B, 10C, and 10D. For example, and in particular, in the case of the diffractive structure illustrated in FIG. 10C, the thickness of high index coating has a potentially similar role as that shown for the blazed grating in adjusting the launched light. For this analysis, the values for the double coated blazed ICG given in Table 3 were utilized.

TABLE 3

| | | | Anti- | | | | | |
|---|---|---|---|---|---|---|---|---|
| K | Design | Blazed | blaze | Top | Bottom | Top | Bottom | Coating |
| launch | λ | Angle | Angle | Width | Width | Coating | Coating | Materials |
| 1.49 | 0.525um | 28 deg | 90 deg | 100 | 60 nm | 80 nm | tuned | TiO₂ |
| | | | | nm | | | from 0 | sandwiched |
| | | | | | | | nm to | between |
| | | | | | | | 110 nm | blazed & |
| | | | | | | | | SiO₂ |

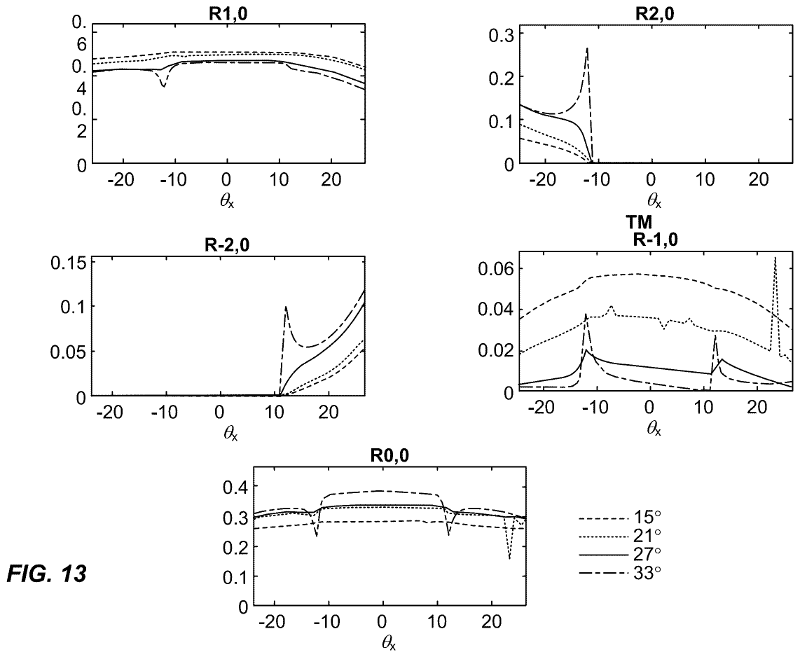

FIG. 13 illustrates diffraction orders for blue light calculated for various blazed angles across the horizontal FOV for the double layer coated blazed grating for an ICG illustrated in FIG. 10C according to an embodiment of the present invention. Depending on the thickness of the higher index layer (TiO₂ in this embodiment) sandwiched between the two layers, the second diffraction order power value and the dependency on the FOV are changed. A uniform distribution of the second order launched power corresponding to coatings in the range of 70-80 nm as illustrated in FIG. 13 is highly desirable and provided by embodiments of the present invention.

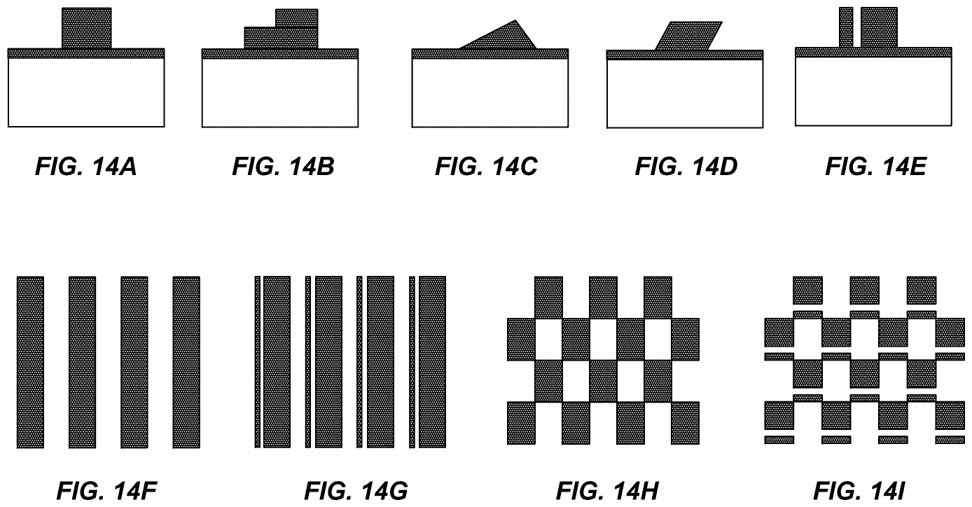

FIGS. 14A-14I illustrate various diffraction grating structures that can be utilized in incoupling gratings, orthogonal pupil expander gratings, exit pupil expander gratings, or combined pupil expander gratings according to an embodiment of the present invention. The diffractive elements, e.g., gratings, utilized in the eyepiece waveguide can be, but are not limited to, binary (illustrated in FIG. 14A), multi-step (illustrated in FIG. 14B), sawtooth or blazed (illustrated in FIG. 14C), slanted (illustrated in FIG. 14D), meta-geometries (illustrated in FIG. 14E), 1D (illustrated in FIGS. 14F and 14G), 2D (illustrated in FIGS. 14H and 14I), 3D structures, morphed hybrid gratings, and the like. Thus, the illustrated diffraction grating architecture examples can be a part of the surface relief gratings comprising the eyepiece waveguide structure.

The grating structures can be present either on the single side of the waveguide or on both sides of the waveguide. Such gratings can be directly imprinted with low to high index nanoimprint polymers (1.5~2.0), inorganic patterns etched directly into high index substrate (e.g., LiNbO₃, LiTaO₃, SiC, etc.) or etched into high index film (e.g., TiO₂, ZrO₂, SiC, Si₃N₄, etc.) over high index substrates or high index (with or without low index) film coatings over imprinted polymer or etched inorganic patterns. Coatings can consist of multiple films of different indices and final etched geometry can consist of one or more than one index of material in at least one grating or a section of the CPE. These diffractive elements can be fabricated by an etch process or a high/low index deposition process.

Since some grating designs diffract more light in the second order than other grating designs, grating designs that balance first order diffraction and second order diffraction can be utilized to balance the light not supported by the eyepiece waveguide after first order diffraction (e.g., first portion 803) and the light supported by the eyepiece waveguide after second order diffraction (e.g., complementary portion 805) to provide a uniformly illuminated field of view. For instance, the inventors have determined that etched, blazed gratings etched into a Lithium Niobate LiNbO₃ substrate with a double dielectric/metal coating, e.g., a multilayer stack of TiO₂ and SiO₂ coated with aluminum, enhance the second order diffraction, thereby providing higher launch efficiency, also referred to as diffraction efficiency, in second order diffraction than that achieved by first order diffraction. Thus, the amount of light incoupled into the first and second orders can be tuned utilizing appropriate grating/coating designs. One of ordinary skill in the art would recognize many variations, modifications, and alternatives.

A variety of materials can be utilized in the eyepiece waveguides discussed herein. The waveguide substrate used for making eyepieces can be fabricated using materials with a range of indices of refraction such as high index glass like 1.7 SCHOTT SF5, 1.8 SF6, HOYA Dense Tantalum Flint glass TAFD55 at 2.01, TAFD65 at 2.06 etc., to crystalline substrates such as Lithium Tantalate LiTaO₃, Lithium Niobate LiNbO₃ at 2.25, Silicon Carbide at 2.65, etc.

Inorganic and organic materials comprising film coatings over waveguide substrates, diffractive and sub-diffractive nanostructures, and/or overcoats on such nanopatterns can include, but are not limited to:

Inorganic High Index material like ZrO₂, Ta₂O₅, Si₃N₄, TiO₂, SiC TiO₂ (n range 2.0 to 2.65) and low index materials such as MgF₂, SiO₂ (n range 1.36 to 1.45).

Organic High index material resist (n range 1.6 to 2.11) and low index material resist (n range 1.15 to 1.6).

Deposition of such inorganic and organic materials can be done using, but not limited to, for inorganic thin films Physical Vapor Deposition (Evaporation, Sputter), Chemical Vapor Deposition (LP PECVD, ALD, AP PECVD, etc.) and coating of organic materials by spincoating, slot-die, micro gravure, spincoating, atomization (spraying), etc.

High index coatings can utilize SiC at 2.5~2.6, TiO₂ at indices of 2.2~2.5, ZrO₂ at 2.1, Si₃N₄ and Silicon Oxynitride where indices can be 1.8~2.0, SiO₂ at 1.45 m MgF₂ at 1.38, etc. Thin film coatings can be achieved over blank or patterned surfaces using Physical Vapor Deposition (PVD) such as Evaporation or Sputter with or without Ion assist (e.g., Ar/O₂) or Chemical Vapor Deposition (CVD) such as Low Pressure PECVD, Atmospheric PECVD, ALD, etc. Fluorinated polymer films with an index of 1.31 can also be coated, where Poly [4,5-difluoro-2,2-bis(trifluoromethyl)-1,3-dioxole-co-tetrafluoroethylene] is dissolved in Fluorinert™ FC-40 up to a 2% concentration by weight. Lower index films (<1.3) can be formulated using sol-gel techniques to a single or multi-layer colloidal film composition with a porous SiO₂-polymer matrix composition. Such low index coatings can be applied by, but not limited to, spin-coating, spray/atomization, inkjetting etc.

The patterned imprintable prepolymer material can include a resin material, such as an epoxy vinyl ester. The resin can include a vinyl monomer (e.g., methyl metacrylate) and/or difunctional or trifunctional vinyl monomers (e.g., diacrylates, triacrylates, dimethacrylates, etc.), with or without aromatic molecules in the monomer. The prepolymer material can include monomer having one or more functional groups such as alkyl, carboxyl, carbonyl, hydroxyl, and/or alkoxy. Sulfur atoms and aromatic groups, which both have higher polarizability, can be incorporated into these acrylate components to boost the index of refraction of the formulation and generally have an index ranging from 1.5~1.75. In some implementations, the prepolymer material can include a cyclic aliphatic epoxy containing resin that can be cured using ultraviolet light and/or heat. In addition, the prepolymer material can include an ultraviolet cationic photoinitiator and a co-reactant to facilitate efficient ultraviolet curing in ambient conditions.

Incorporating inorganic nanoparticles (NP) such as ZrO₂ and TiO₂ into such imprintable resin polymers can boost index of refraction significantly further up to 2.1. Pure ZrO₂ and TiO₂ crystals can reach 2.2 and 2.4-2.6 index at 532 nm, respectively. For the preparation of optical nanocomposites of acrylate monomer and inorganic nanoparticle, the particle size can be smaller than 10 nm to avoid excessive Rayleigh scattering. Due to its high specific surface area, high polarity, and incompatibility with the cross-linked polymer matrix, a ZrO₂ NP has a tendency to agglomerate in the polymer matrix. Surface modification of NPs can be used to overcome this problem. In this technique, the hydrophilic surface of ZrO₂ is modified to be compatible with organics, thus enabling the NP to be uniformly mixed with the polymer. Such modification can be done with silane and carboxylic acid containing capping agents. One end of the capping agent is bonded to ZrO₂ surface; the other end of the capping agent either contains a functional group that can participate in acrylate crosslinking or a non-functional organic moiety. Examples of surface modified sub-10 nm ZrO₂ particles are those supplied by Pixelligent Technologies™ and Cerion Advanced Materials™. These functionalized nanoparticles are typically sold uniformly suspended in solvent as uniform blends, which can be combined with other base materials to yield resist formulations with jettable viscosity and increased index of refraction.

The pre-polymer material can be patterned using a template (superstrate, rigid or flexible) with an inverse-tone of the optically functional nano-structures (diffractive and sub-diffractive) directly in contact with the liquid pre-polymer. The liquid state pre-polymer material can be dispensed over the substrate or surface to be patterned using, but not limited to, inkjetting drop on demand or continuous jetting system, slot-die coating, spin-coating, doctor blade coating, micro-gravure coating, screen-printing, spray or atomization, etc. The template is brought in contact with the liquid and once the liquid fills the template features, to crosslink and pattern, the prepolymer with diffractive patterns with a template in contact (for example, in case of Imprint Lithography e.g. J-FIL™ where prepolymer material is inkjet-dispensed) includes exposing the prepolymer to actinic radiation having a wavelength between 310 nm and 410 nm and an intensity between 0.1 J/cm² and 100 J/cm². The method can further include, while exposing the prepolymer to actinic radiation, applying heat of the prepolymer to a temperature between 40° C. and 120° C.

For adhesion promotion between the pre-polymer material post-patterning (template/mold demolding) and curing over a desired surface or substrate, crosslinking silane coupling agents can be used. These agents have an organofunctional group at one end and a hydrolysable group at the other end that form durable bonds with different types of organic and inorganic materials. An example of the organofunctional group can be an acryloyl which can crosslink into a patternable polymer material to form the desired optical pattern/shape. Conversely, the template or molds can be coated with similar coating where the acryloyl end is replaced with a fluorinated chain which can reduce the surface energy and thus act as a nonbonding but release site. Vapor deposition is carried out at low pressures where the coupling agent is delivered in vapor form with or without the use of an inert gas such as N₂, for example, with the presence of activated —O and/or —OH groups present on the surface of material to be coated. The vapor coating process can deposit monolayer films as thin as 0.5 nm~0.7 nm and film thickness can be increased depending on the particular application.

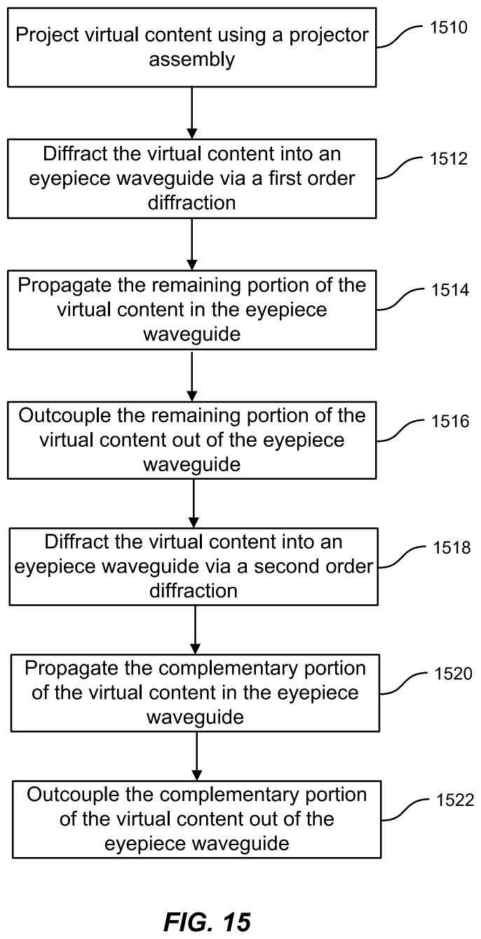

FIG. 15 is a simplified flowchart illustrating a method of operating an eyepiece waveguide of an augmented reality system according to an embodiment of the present invention. The method includes projecting virtual content using a projector assembly (1510) and diffracting the virtual content into the eyepiece waveguide via a first order diffraction (1512). A first portion of the virtual content is clipped to produce a remaining portion of the virtual content.

Diffracting the virtual content into the eyepiece waveguide via a first order diffraction can include diffracting light in a first wavelength range in a first direction using a first subpupil of an incoupling grating, diffracting light in a second wavelength range in the first direction using a second subpupil of the incoupling grating, and diffracting light in a third wavelength range in a second direction using a third subpupil of the incoupling grating.

The method also includes propagating the remaining portion of the virtual content in the eyepiece waveguide (1514) and outcoupling the remaining portion of the virtual content out of the eyepiece waveguide (1516). Propagating the remaining portion of the virtual content in the eyepiece waveguide can include propagating a full field of view for a first wavelength range, a full field of view for a second wavelength range, and a partial field of view of a third wavelength range, the first wavelength range can be red wavelengths, the second wavelength range can be green wavelengths, the third wavelength range can be blue wavelengths, and the partial field of view can lack a nasal region. The remaining portion can be a partial view of view. Outcoupling the remaining portion of the virtual content out of the eyepiece waveguide comprises diffraction from gratings disposed on a world side of the eyepiece waveguide.

The method further includes diffracting the virtual content into the eyepiece waveguide via a second order diffraction (1518). A second portion of the virtual content is clipped to produce a complementary portion. Moreover, the method includes propagating the complementary portion of the virtual content in the eyepiece waveguide (1520) and outcoupling the complementary portion of the virtual content out of the eyepiece waveguide (1522). Propagating the second portion of the virtual content in the eyepiece waveguide can include propagating a partial field of view for the short wavelengths of the range of wavelengths. The partial field of view can lack a temple region.

The first portion can occupy a first area of a field of view and the complementary portion can occupy a second area of the field of view, wherein the second area is greater than or equal to the first area. The complementary portion can occupy a larger area of a field of view than the first portion. The virtual content can include a range of wavelengths and diffracting the virtual content into the eyepiece waveguide via a second order diffraction can include diffracting short wavelengths of the range of wavelengths. The first portion of the virtual content can include a temple portion of a field of view and the second portion of the virtual content comprises a nasal portion of the field of view. The second order diffraction can be characterized by a higher launch efficiency than the first order diffraction.

The virtual content can include a range of wavelengths, diffracting the virtual content into the eyepiece waveguide via the first order diffraction can include diffracting short wavelengths of the range of wavelengths, and diffracting the virtual content into the eyepiece waveguide via the second order diffraction comprises diffracting the short wavelengths of the range of wavelengths. The eyepiece waveguide can include a single active layer, for example, LiNbO₃ or SiC material. Propagating the first portion of the virtual content in the eyepiece waveguide and outcoupling the first portion of the virtual content out of the eyepiece waveguide can include diffraction from a combined pupil expander diffractive optical element. Propagating the second portion of the virtual content in the eyepiece waveguide and outcoupling the second portion of the virtual content out of the eyepiece waveguide can include diffraction from the combined pupil expander diffractive optical element. The combined pupil expander diffractive optical element can include a first region characterized by a first grating orientation and a second region characterized by a second grating orientation different from the first grating orientation. Diffracting the virtual content into the eyepiece waveguide via a first order diffraction and diffracting the virtual content into the eyepiece waveguide via a second order diffraction can include diffraction from an incoupling diffractive optical element including blazed gratings, for example, blazed gratings etched into the eyepiece waveguide. The blazed gratings ca be imprinted into the eyepiece waveguide and the blazed gratings can include metabinary gratings. The incoupling diffractive optical element can include one or more coating layers on the blazed gratings. The one or more coating layers can include two or more dielectric layers.

It should be appreciated that the specific steps illustrated in FIG. 15 provide a particular method of operating an eyepiece waveguide of an augmented reality system according to an embodiment of the present invention. Other sequences of steps may also be performed according to alternative embodiments. For example, alternative embodiments of the present invention may perform the steps outlined above in a different order. Moreover, the individual steps illustrated in FIG. 15 may include multiple sub-steps that may be performed in various sequences as appropriate to the individual step. Furthermore, additional steps may be added or removed depending on the particular applications. One of ordinary skill in the art would recognize many variations, modifications, and alternatives.

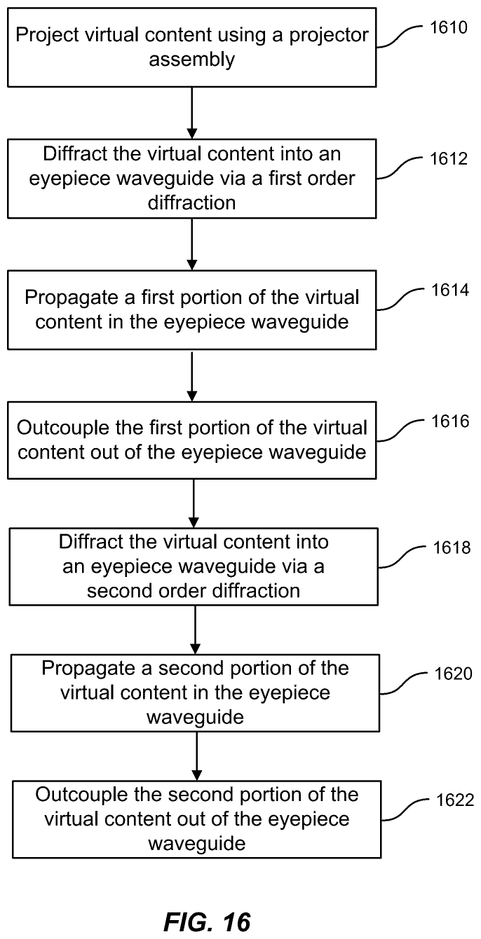

FIG. 16 is a simplified flowchart illustrating a method of operating an eyepiece waveguide of an augmented reality system according to another embodiment of the present invention. The method includes projecting virtual content using a projector assembly (1610), diffracting the virtual content into the eyepiece waveguide via a first order diffraction (1612), propagating a first portion of the virtual content in the eyepiece waveguide (1614), and outcoupling the first portion of the virtual content out of the eyepiece waveguide (1616). The method also includes diffracting the virtual content into the eyepiece waveguide via a second order diffraction (1618), propagating a second portion of the virtual content in the eyepiece waveguide (1620), and outcoupling the second portion of the virtual content out of the eyepiece waveguide (1622).

Diffracting the virtual content into the eyepiece waveguide via a first order diffraction can include diffracting light in a first wavelength range in a first direction using a first subpupil of an incoupling grating, diffracting light in a second wavelength range in the first direction using a second subpupil of the incoupling grating, and diffracting light in a third wavelength range in a second direction using a third subpupil of the incoupling grating. Propagating the first portion of the virtual content in the eyepiece waveguide can include propagating a full field of view for a first wavelength range, a full field of view for a second wavelength range, and a partial field of view of a third wavelength range. The first wavelength range can include red wavelengths, the second wavelength range can include green wavelengths, the third wavelength range can include blue wavelengths, and the partial field of view can lack a nasal region.

Outcoupling the first portion of the virtual content out of the eyepiece waveguide can include diffraction from gratings disposed on a world side of the eyepiece waveguide. The virtual content can include a range of wavelengths and diffracting the virtual content into the eyepiece waveguide via a second order diffraction can include diffracting short wavelengths of the range of wavelengths. Propagating the second portion of the virtual content in the eyepiece waveguide can include propagating a partial field of view for the short wavelengths of the range of wavelengths. The partial field of view can lack a temple region. The first portion of the virtual content can include a temple portion of a field of view and the second portion of the virtual content can include a nasal portion of the field of view. The second order diffraction can be characterized by a higher launch efficiency than the first order diffraction. The virtual content can include a range of wavelengths, diffracting the virtual content into the eyepiece waveguide via the first order diffraction can include diffracting short wavelengths of the range of wavelengths, and diffracting the virtual content into the eyepiece waveguide via the second order diffraction can include diffracting the short wavelengths of the range of wavelengths. The eyepiece waveguide can include a single active layer. The eyepiece waveguide can include LiNbO₃ or SiC.

Propagating the first portion of the virtual content in the eyepiece waveguide and outcoupling the first portion of the virtual content out of the eyepiece waveguide can include diffraction from a combined pupil expander diffractive optical element. Propagating the second portion of the virtual content in the eyepiece waveguide and outcoupling the second portion of the virtual content out of the eyepiece waveguide can include diffraction from the combined pupil expander diffractive optical element. The combined pupil expander diffractive optical element can include a first region characterized by a first grating orientation and a second region characterized by a second grating orientation different from the first grating orientation. Diffracting the virtual content into the eyepiece waveguide via a first order diffraction and diffracting the virtual content into the eyepiece waveguide via a second order diffraction can include diffraction from incoupling diffractive optical elements etched into the eyepiece waveguide. Diffracting the virtual content into the eyepiece waveguide via a first order diffraction and diffracting the virtual content into the eyepiece waveguide via a second order diffraction can include diffraction from an incoupling diffractive optical element including blazed gratings. The blazed gratings, which can include metabinary gratings, can be etched into the eyepiece waveguide or imprinted into the eyepiece waveguide. The incoupling diffractive optical element can include one or more coating layers on the blazed gratings. The one or more coating layers can include two or more dielectric layers.

It should be appreciated that the specific steps illustrated in FIG. 16 provide a particular method of operating an eyepiece waveguide of an augmented reality system according to another embodiment of the present invention. Other sequences of steps may also be performed according to alternative embodiments. For example, alternative embodiments of the present invention may perform the steps outlined above in a different order. Moreover, the individual steps illustrated in FIG. 16 may include multiple sub-steps that may be performed in various sequences as appropriate to the individual step. Furthermore, additional steps may be added or removed depending on the particular applications. One of ordinary skill in the art would recognize many variations, modifications, and alternatives.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is method of operating an augmented reality system comprising: projecting virtual content using a projector assembly; diffracting the virtual content into the eyepiece waveguide via a first order diffraction, wherein a first portion of the virtual content is clipped to produce a remaining portion of the virtual content; propagating the remaining portion of the virtual content in the eyepiece waveguide; outcoupling the remaining portion of the virtual content out of the eyepiece waveguide; diffracting the virtual content into the eyepiece waveguide via a second order diffraction, wherein a second portion of the virtual content is clipped to produce a complementary portion; propagating the complementary portion of the virtual content in the eyepiece waveguide; and outcoupling the complementary portion of the virtual content out of the eyepiece waveguide.

Example 2 is the method of example 1, wherein the first portion occupies a first area of a field of view and the complementary portion occupies a second area of the field of view, wherein the second area is greater than or equal to the first area.

Example 3 is the method of example(s) 1-2, wherein the complementary portion occupies a larger area of a field of view than the first portion.

Example 4 is the method of example(s) 1-3, wherein diffracting the virtual content into the eyepiece waveguide via a first order diffraction comprises: diffracting light in a first wavelength range in a first direction using a first subpupil of an incoupling grating; diffracting light in a second wavelength range in the first direction using a second subpupil of the incoupling grating; and diffracting light in a third wavelength range in a second direction using a third subpupil of the incoupling grating.

Example 5 is the method of example(s) 1-4, wherein propagating the remaining portion of the virtual content in the eyepiece waveguide comprises propagating a full field of view for a first wavelength range, a full field of view for a second wavelength range, and a partial field of view of a third wavelength range.

Example 6 is the method of example(s) 1-5, wherein: the first wavelength range comprises red wavelengths; the second wavelength range comprises green wavelengths; the third wavelength range comprises blue wavelengths; and the partial field of view lacks a nasal region.

Example 7 is the method of example(s) 1-6, wherein the remaining portion comprises the partial view of view.

Example 8 is the method of example(s) 1-7, wherein outcoupling the remaining portion of the virtual content out of the eyepiece waveguide comprises diffraction from gratings disposed on a world side of the eyepiece waveguide.

Example 9 is the method of example(s) 1-8, wherein the virtual content comprises a range of wavelengths and diffracting the virtual content into the eyepiece waveguide via a second order diffraction comprises diffracting short wavelengths of the range of wavelengths.

Example 10 is the method of example(s) 1-9, wherein propagating the second portion of the virtual content in the eyepiece waveguide comprises propagating a partial field of view for the short wavelengths of the range of wavelengths.

Example 11 is the method of example(s) 1-10, wherein the partial field of view lacks a temple region.

Example 12 is the method of example(s) 1-11, wherein the first portion of the virtual content comprises a temple portion of a field of view; and the second portion of the virtual content comprises a nasal portion of the field of view.

Example 13 is the method of example(s) 1-12, wherein the second order diffraction is characterized by a higher launch efficiency than the first order diffraction.

Example 14 is the method of example(s) 1-13, wherein: the virtual content comprises a range of wavelengths; diffracting the virtual content into the eyepiece waveguide via the first order diffraction comprises diffracting short wavelengths of the range of wavelengths; and diffracting the virtual content into the eyepiece waveguide via the second order diffraction comprises diffracting the short wavelengths of the range of wavelengths.

Example 15 is the method of example(s) 1-14, wherein the eyepiece waveguide includes a single active layer.

Example 16 is the method of example(s) 1-15, wherein the eyepiece waveguide includes LiNbO₃ or SiC.

Example 17 is the method of example(s) 1-16, wherein propagating the first portion of the virtual content in the eyepiece waveguide and outcoupling the first portion of the virtual content out of the eyepiece waveguide comprise diffraction from a combined pupil expander diffractive optical element.

Example 18 is the method of example(s) 1-17, wherein propagating the second portion of the virtual content in the eyepiece waveguide and outcoupling the second portion of the virtual content out of the eyepiece waveguide comprise diffraction from the combined pupil expander diffractive optical element.

Example 19 is the method of example(s) 1-18, wherein the combined pupil expander diffractive optical element includes a first region characterized by a first grating orientation and a second region characterized by a second grating orientation different from the first grating orientation.

Example 20 is the method of example(s) 1-19, wherein diffracting the virtual content into the eyepiece waveguide via a first order diffraction and diffracting the virtual content into the eyepiece waveguide via a second order diffraction comprise diffraction from an incoupling diffractive optical element including blazed gratings.

Example 21 is the method of example(s) 1-20, wherein the blazed gratings are etched into the eyepiece waveguide.

Example 22 is the method of example(s) 1-22, wherein the blazed gratings are imprinted into the eyepiece waveguide.

Example 23 is the method of example(s) 1-23, wherein the blazed gratings comprise metabinary gratings.

Example 24 is the method of example(s) 1-24, wherein the incoupling diffractive optical element comprises one or more coating layers on the blazed gratings.

Example 25 is the method of example(s) 1-25, wherein the one or more coating layers comprise two or more dielectric layers.

Example 26 is a method of operating an eyepiece waveguide of an augmented reality system, the method comprising: projecting virtual content using a projector assembly; diffracting the virtual content into the eyepiece waveguide via a first order diffraction; propagating a first portion of the virtual content in the eyepiece waveguide; outcoupling the first portion of the virtual content out of the eyepiece waveguide; diffracting the virtual content into the eyepiece waveguide via a second order diffraction; propagating a second portion of the virtual content in the eyepiece waveguide; and outcoupling the second portion of the virtual content out of the eyepiece waveguide.

Example 27 is the method of example 26 wherein diffracting the virtual content into the eyepiece waveguide via a first order diffraction comprises: diffracting light in a first wavelength range in a first direction using a first subpupil of an incoupling grating; diffracting light in a second wavelength range in the first direction using a second subpupil of the incoupling grating; and diffracting light in a third wavelength range in a second direction using a third subpupil of the incoupling grating.

Example 28 is the method of example(s) 26-27 wherein propagating the first portion of the virtual content in the eyepiece waveguide comprises propagating a full field of view for a first wavelength range, a full field of view for a second wavelength range, and a partial field of view of a third wavelength range.

Example 29 is the method of example(s) 26-28 wherein: the first wavelength range comprises red wavelengths; the second wavelength range comprises green wavelengths; the third wavelength range comprises blue wavelengths; and the partial field of view lacks a nasal region.

Example 30 is the method of example(s) 26-29 wherein outcoupling the first portion of the virtual content out of the eyepiece waveguide comprises diffraction from gratings disposed on a world side of the eyepiece waveguide.

Example 31 is the method of example(s) 26-30 wherein the virtual content comprises a range of wavelengths and diffracting the virtual content into the eyepiece waveguide via a second order diffraction comprises diffracting short wavelengths of the range of wavelengths.

Example 32 is the method of example(s) 26-31 wherein propagating the second portion of the virtual content in the eyepiece waveguide comprises propagating a partial field of view for the short wavelengths of the range of wavelengths.

Example 33 is the method of example(s) 26-32 wherein the partial field of view lacks a temple region.

Example 34 is the method of example(s) 26-33 wherein: the first portion of the virtual content comprises a temple portion of a field of view; and the second portion of the virtual content comprises a nasal portion of the field of view.

Example 35 is the method of example(s) 26-34 wherein the second order diffraction is characterized by a higher launch efficiency than the first order diffraction.

Example 36 is the method of example(s) 26-35 wherein: the virtual content comprises a range of wavelengths; diffracting the virtual content into the eyepiece waveguide via the first order diffraction comprises diffracting short wavelengths of the range of wavelengths; and diffracting the virtual content into the eyepiece waveguide via the second order diffraction comprises diffracting the short wavelengths of the range of wavelengths.

Example 37 is the method of example(s) 26-36 wherein the eyepiece waveguide includes a single active layer.

Example 38 is the method of example(s) 26-37 wherein the eyepiece waveguide includes LiNbO₃ or SiC.

Example 39 is the method of example(s) 26-38 wherein propagating the first portion of the virtual content in the eyepiece waveguide and outcoupling the first portion of the virtual content out of the eyepiece waveguide comprise diffraction from a combined pupil expander diffractive optical element.

Example 40 is the method of example(s) 26-39 wherein propagating the second portion of the virtual content in the eyepiece waveguide and outcoupling the second portion of the virtual content out of the eyepiece waveguide comprise diffraction from the combined pupil expander diffractive optical element.

Example 41 is the method of example(s) 26-40 wherein the combined pupil expander diffractive optical element includes a first region characterized by a first grating orientation and a second region characterized by a second grating orientation different from the first grating orientation.

Example 42 is the method of example(s) 26-41 wherein diffracting the virtual content into the eyepiece waveguide via a first order diffraction and diffracting the virtual content into the eyepiece waveguide via a second order diffraction comprises diffraction from incoupling diffractive optical elements etched into the eyepiece waveguide.

Example 43 is the method of example(s) 26-42 wherein diffracting the virtual content into the eyepiece waveguide via a first order diffraction and diffracting the virtual content into the eyepiece waveguide via a second order diffraction comprise diffraction from an incoupling diffractive optical element including blazed gratings.

Example 44 is the method of example(s) 26-43 wherein the blazed gratings are etched into the eyepiece waveguide.

Example 45 is the method of example(s) 26-43 wherein the blazed gratings are imprinted into the eyepiece waveguide.

Example 46 is the method of example(s) 26-43 wherein the blazed gratings comprise metabinary gratings.

Example 47 is the method of example(s) 26-43 wherein the incoupling diffractive optical element comprises one or more coating layers on the blazed gratings.

Example 48 is the method of example(s) 26-47 wherein the one or more coating layers comprise two or more dielectric layers.

In the foregoing specification, the disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than restrictive sense.

Indeed, it will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Accordingly, the claims are not intended to be limited to the embodiments shown herein, but are to be accorded the widest scope consistent with this disclosure, the principles and the novel features disclosed herein.

What is claimed is:

1. A method of operating an eyepiece waveguide of an augmented reality system, the method comprising:
projecting virtual content using a projector assembly;
diffracting the virtual content into the eyepiece waveguide via a first order diffraction, wherein a first portion of the virtual content is clipped to produce a remaining portion of the virtual content;
propagating the remaining portion of the virtual content in the eyepiece waveguide;
outcoupling the remaining portion of the virtual content out of the eyepiece waveguide;
diffracting the virtual content into the eyepiece waveguide via a second order diffraction, wherein a second portion of the virtual content is clipped to produce a complementary portion;
propagating the complementary portion of the virtual content in the eyepiece waveguide; and
outcoupling the complementary portion of the virtual content out of the eyepiece waveguide.

2. The method of claim 1 wherein the first portion occupies a first area of a field of view and the complementary portion occupies a second area of the field of view, wherein the second area is greater than or equal to the first area.

3. The method of claim 1 wherein the complementary portion occupies a larger area of a field of view than the first portion.

4. The method of claim 1 wherein diffracting the virtual content into the eyepiece waveguide via a first order diffraction comprises:
diffracting light in a first wavelength range in a first direction using a first subpupil of an incoupling grating;
diffracting light in a second wavelength range in the first direction using a second subpupil of the incoupling grating; and
diffracting light in a third wavelength range in a second direction using a third subpupil of the incoupling grating.

5. The method of claim 1 wherein propagating the remaining portion of the virtual content in the eyepiece waveguide comprises propagating a full field of view for a first wavelength range, a full field of view for a second wavelength range, and a partial field of view of a third wavelength range.

6. The method of claim 5 wherein:
the first wavelength range comprises red wavelengths;
the second wavelength range comprises green wavelengths;
the third wavelength range comprises blue wavelengths;
the partial field of view lacks a nasal region; and
the remaining portion comprises the partial view of view.

7. The method of claim 1 wherein outcoupling the remaining portion of the virtual content out of the eyepiece waveguide comprises diffraction from gratings disposed on a world side of the eyepiece waveguide.

8. The method of claim 1 wherein the virtual content comprises a range of wavelengths and diffracting the virtual content into the eyepiece waveguide via a second order diffraction comprises diffracting short wavelengths of the range of wavelengths.

9. The method of claim 8 wherein propagating the second portion of the virtual content in the eyepiece waveguide comprises propagating a partial field of view for the short wavelengths of the range of wavelengths, wherein the partial field of view lacks a temple region.

10. The method of claim 1 wherein:
the first portion of the virtual content comprises a temple portion of a field of view; and
the second portion of the virtual content comprises a nasal portion of the field of view.

11. The method of claim 1 wherein the second order diffraction is characterized by a higher launch efficiency than the first order diffraction.

12. The method of claim 1 wherein:
the virtual content comprises a range of wavelengths;
diffracting the virtual content into the eyepiece waveguide via the first order diffraction comprises diffracting short wavelengths of the range of wavelengths; and
diffracting the virtual content into the eyepiece waveguide via the second order diffraction comprises diffracting the short wavelengths of the range of wavelengths.

13. The method of claim 1 wherein the eyepiece waveguide includes a single active layer.

14. The method of claim 1 wherein the eyepiece waveguide includes LiNbO₃ or SiC.

15. The method of claim 1 wherein propagating the first portion of the virtual content in the eyepiece waveguide and outcoupling the first portion of the virtual content out of the eyepiece waveguide comprise diffraction from a combined pupil expander diffractive optical element including a first region characterized by a first grating orientation and a second region characterized by a second grating orientation different from the first grating orientation.

16. The method of claim 15 wherein propagating the second portion of the virtual content in the eyepiece waveguide and outcoupling the second portion of the virtual content out of the eyepiece waveguide comprise diffraction from the combined pupil expander diffractive optical element.

17. The method of claim 1 wherein diffracting the virtual content into the eyepiece waveguide via a first order diffraction and diffracting the virtual content into the eyepiece waveguide via a second order diffraction comprise diffraction from an incoupling diffractive optical element including blazed gratings.

18. The method of claim 17 wherein the blazed gratings are etched or imprinted into the eyepiece waveguide.

19. The method of claim 17 wherein the blazed gratings comprise metabinary gratings.

20. The method of claim 17 wherein the incoupling diffractive optical element comprises one or more coating layers on the blazed gratings.
